(19) United States
(12) Patent Application Publication
(10) Pub. No.: US 2013/0246396 A1
(43) Pub. Date: Sep. 19, 2013

(54) Multi-Source Decision Support System

(71) Applicant: BLUE WATERS HOLDINGS LLC, Dunn, NC (US)

(72) Inventors: Robert Clare, Dunn, NC (US); Walter Thomas Greenberg, Alpharetta, GA (US)

(73) Assignee: BLUE WATERS HOLDINGS LLC, Dunn, NC (US)

(21) Appl. No.: 13/791,891

(22) Filed: Mar. 8, 2013

Related U.S. Application Data
(60) Provisional application No. 61/608,518, filed on Mar. 8, 2012.

(51) Int. Cl. G06F 17/30

(52) U.S. Cl. CPC G06F 17/30554
USPC 707/722

(57) ABSTRACT

A multi-source decision support system (MSDSS) is described that includes methods and analytical tools for dynamically ingesting and discovering information from multiple sources, such as social media sources, correlating and organizing the information, and providing a multi-user integrated work environment to generate a common operating picture.

### CROSS-REFERENCE TO RELATED APPLICATIONS

This application claims the benefit of U.S. provisional application Ser. No. 61/608,518 filed Mar. 8, 2012, which is incorporated herein by reference.

### BACKGROUND

The purpose of an Operational Picture (OP) has been to create a sight picture for leadership at all levels of command of an organization hierarchy. The OP becomes a Common Operational Picture (COP) when the perspectives of many organizational users are combined. For this to be effective the picture should be so intuitive that it instantly gives a snapshot to whoever looks at it and possess the ability to harness all the available information and achieve organizational objectives.

Examples in which a COP is used is in warfare, policing operations, conducting counter organized crime, and counter terrorist insurgency operations. In the many societies that have conducted counter insurgency operations—one theme has resonated clearly: an insurgent's success has been tied to their ability to leverage military, social, political, and economic issues to advance their cause in a timelier, productive and effective manner as opposed to following the regiments of decades of training and conventional warfare. Conversely, the conventional military's lack of nimble political, social, and economic prowess greatly contributes to the breakdown in their ability to meet their objectives and operations. A COP aids the authority conducting the counter operations in overcoming their limitations by organization information on the criminal/terrorist/insurgency group in formulating a course of action (COA).

Traditionally intelligence has been connected to operational needs based on its ability to fill a gap in the current or projected understanding of the operational/battle space and its threats. Intelligence gathering at the operational level is usually targeted to confirm or deny assumptions during COA development. Indicators then are viewed as positive or negative evidence of activity, which may influence the selection of a particular COA.

One of the limiting factors, however, surrounding the creation of a COP that drives a particular COA is the fact that the COP is solely based on the known available sources and logistics, leaving out potential sources of data that could be harnessed.

### SUMMARY

Various embodiments described herein overcome the limitations above and provide other benefits by providing a multi-source decision support system (MSDSS) that includes methods and analytical tools for dynamically ingesting and discovering information from multiple sources, such as social media sources, correlating and organizing the information, and providing a multi-user integrated work environment to generate a COP.

Detailed aspects of the various embodiments are further discussed below.

### BRIEF DESCRIPTION OF THE DRAWINGS

FIG. 1 is a block diagram showing elements in an illustrative network in which some embodiments may be practiced.

FIG. 2 is a block diagram showing elements of an illustrative apparatus in which some embodiments may be practiced.

FIG. 3 illustrates a flow chart that may be performed in accordance with one or more embodiments.

FIGS. 4-60 illustrate various views of a user interface according to one or more embodiments.

### DETAILED DESCRIPTION

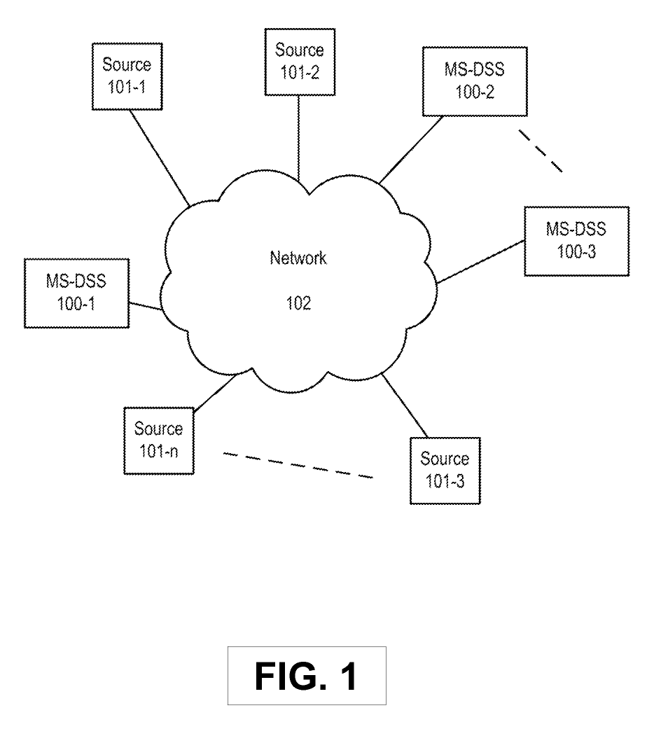

FIG. 1 illustrates a network environment in which various aspects may operate. The environment includes a network 102 that communicatively connects one or more MSDSS systems 100-1 to 100-m and one or more information source systems 101-1 to 101-n.

MSDSS systems 100-1 to 100-m may be implemented with one or more computers/servers that may be interconnected through network 102, with each MSDSS system 100 comprising one or more subsystems/computers interconnected through separate local networks (no shown). Network 100 may be a combination of individual different networks distributed and connected globally, each having a combination of physical components including landline (e.g., coaxial cable, fiber optic), local cellular wireless, satellite wireless, etc. Network 102 may comprise portions of the Internet, which uses the standard Internet protocol suite (TCP/IP) to exchange information.

Information source systems 101-1 to 101-m may include computers and systems that provide public or private information over the network 103 (e.g., the Internet). Such systems may include computers configured for peer-to-peer communications and servers (e.g., web servers), that provide/host services, such as social media services, news services, blogs, etc. Social media services may include a wide range of applications that enable people from around the world to communicate over network 102. Social media services may include web-based and mobile technologies used for interactive dialogue between users or groups of users. Social media services may be Internet based and enable the exchange of user or group generated content.

Social media services may be open (e.g., viewable by the general public or a subset of the general public) or may be closed (e.g., limited to a specific group of users with certain credentials required by the media). Social media may take the form of magazines and other print media, audio and/or video podcasts, web blogs, social blogs, and other internet forums, photos, maps, online gaming, television and radio with or without interactive audiences and call-in participation, email, instant messaging, file/music/video sharing, VOIP, texting, crowd sourcing, cellular telephony, etc., and aggregates and combinations thereof. Social media services may be provided by standalone systems, or may have multiple different social media systems integrated. Social media services may provide presence information of users or groups of users, indicating for example: a location of a user, a physical status of a user, physical surroundings of a user, modes of communication of a user, a schedule or plan of a user, whether a user is logged on to a social media system (e.g., source 101-1), whether a user is active (e.g., logged in, currently typing, etc.) on a social media system, etc.

Some examples of social media systems include Wikipedia®, Twitter®, YouTube®, FaceBook®, Second Life®, Google+®, etc. Social media systems may use one or more criteria to group and filter users and communications by interest, subject matter, demographics, geospatial location, theme, user selected preferences, user access habits, etc.

Information source systems 101-1 to 101-m may further include other open and closed sources of information, such as electronic magazines, newspapers, public bulletins, business web sites, informational websites, government informational web sites, etc.

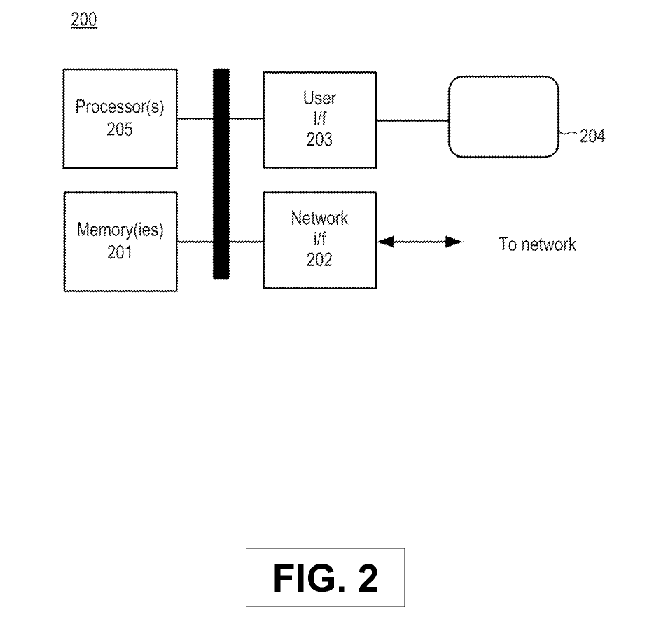

FIG. 2 illustrates an illustrative apparatus 200 on which any of the components of network 102, MSDSS components 100, or information source systems 101 may be implemented. Apparatus 200 may include one or more processors 205, which may include microprocessors, ASICS, FPGAs, and other logic configured to implement the algorithms used by the various systems to implement the various embodiments. MSDSS and other systems may be implemented directly with the processors 205, or additionally with computer executable instructions (i.e., software) executed by the processors. Apparatus 200 may include one or more memories 201 (e.g., ROM, RAM, FLASH, Optical disks, magnetic disks, hard disk drives, etc.), which may store the computer executable instructions and data for implementing various embodiments described herein.

One or more apparatus 200 may be used to implement any of computer devices described herein and may include stationary systems such as blade computers, desktop computers, main-frames, etc., and may also include mobile devices such as portable computers, cell phones, PDAs, etc.

Apparatus 200 may include a user interface 203, which may provide an interface to user interface components 204, such as keyboards, I/O ports, user input devices (e.g., trackballs, mice, touchpads, touchscreens, etc.,), display interfaces, and display devices to enable users to interact with various embodiments. Various apparatus 200 may operate in an open environment, a secure environment, or a combination thereof. For a secured environment, the computers, servers, network components, etc. implemented by apparatus 200 may include security devices, such as encryption/decryption hardware and software, and user authentication equipment (e.g., encryption card readers, fingerprint readers, biometric devices, etc.).

Apparatus 200 may also include one or more network interfaces 202, for communicatively connecting to network 102 and to other apparatus 200. Network interface may include both wired and wireless communication interfaces.

Each MSDSS may include computer executable instructions/software (e.g., a Java 2 Platform Enterprise Edition (J2EE) technology components) executed by one or more apparatus 200, and may be an anonymous, real time social media discovery, situational awareness and analytics tool that draws from unclassified sources in order to generate a COP and support various COAs. In doing so, various embodiments may ingest and store data from multiple sources 101 (e.g., social media services), correlate the data, disseminate the discovery and correlation of the data to multiple users within a community and designate teams (e.g., within the communities), receive user input to vet and classify the information. Other aspects enable real-time communication (e.g., chat, tactical radio, VOIP) between users associated with the team

In various embodiments, an MSDSS 100 may organize and present data in a hierarchical structure including organizations, cases, gist concepts, campaigns, sessions, and reports, and present the data in an interactive graphical user interface that geospatially presents the data to users of the system. An MSDSS may support multiple different organizations (e.g., department of defense, FBI, etc.) A case is the highest level data structure, which includes all information related to a particular Common Operational Picture. Each case may be associated with a different organization that uses MSDSS, and more than one case can be associated with a single organization.

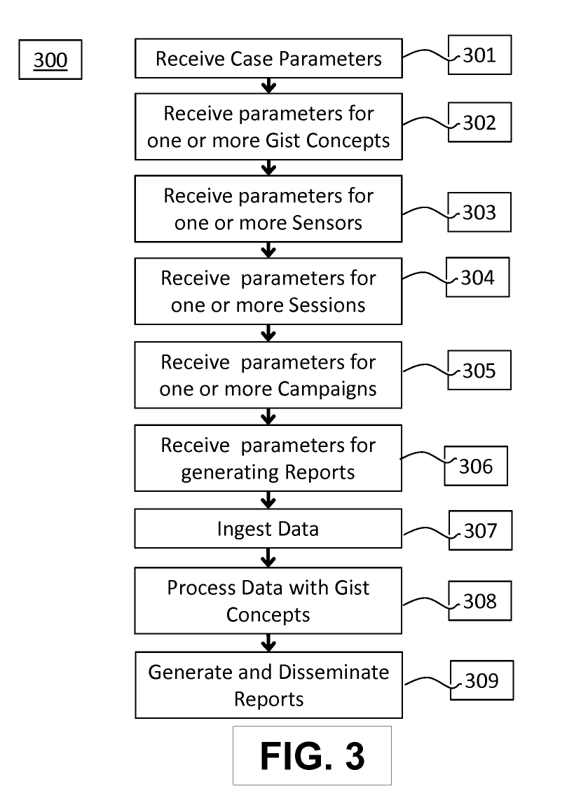

Within a case are one or more gist concepts, which is a brevity/concise format used to express an idea or concept based on a longer detailed narrative/set of data. A gist concept may include one or more parameters that are compared to social media or other ingested data. When there is a correspondence (e.g., a match) between the social media data and the gist concept parameters, a geospatially representable indication (e.g., a gist indication) is displayed on a map at a location associated with the social media data (e.g., an origination or intended destination location of the information). A gist concept may specify thematic and temporal relations and patterns in social media data as discussed with respect to FIG. 3.

A campaign may include a collection of gist concepts applied to a particular geospatial region. A campaign region may be identified on a map by, for example, adding an outline layer that bounds the geospatial region. A session may include data collection parameters within a campaign for specifying ingest of data from one or more sources. Session parameters may specify a time frame for data collection, one or more sensors or sources for data collection (e.g., a twitter feed, a blog website, etc.), and other criteria for ingesting data to be compared to gist concepts within the campaign. A report may be generated to include details compiled by MSDSS for a case, gists, campaigns, and sessions processed/run by the MSDSS.

Various aspects of the MSDSS are described herein in the context of a Special Operating Forces (SOF) counter insurgency scenario for illustrative purposes to explain various aspects. In an SOF scenario, MSDSS may fuse data gathered using traditional intelligence and operational techniques (e.g., manually inputting, eavesdropping, interrogation, electronic intercept) with data from open and closed global social media services.

The systems and methods described herein are further applicable to other scenarios for developing a COP for driving COAs. For example, various aspects may use MSDSS 100 applied to logistics management, manufacturing supply line management, commodities trading, financial investing, natural disaster response, and any other operational scenario, where real-time knowledge gathered from social media services may benefit operational decision making.

FIG. 3 includes a process 300 according to various aspects for generating and running a case. In step 301, the MSDSS receives parameters that define a case. Such parameters may include a case name, identification of personnel/users, communications between personnel, and other logistical data as further described herein. Case parameters may be received by one or more users via user input devices (e.g., a keyboard), either locally at an MSDSS computer/server, or remotely.

In step 302, parameters are received from one or more user input devices (e.g., a keyboard) that define one or more gist concepts. Gist parameters may be three dimensional in nature, including: 1) Temporal parameters, 2) Geospatial parameters, and 3) Thematic parameters. Temporal parameters may specify data generated, disseminated in an open or closed environment, and/or captured on certain dates and times, during particular times of day, occurring periodically, coinciding with specific events, etc. Geospatial parameters may specify data that was generated, disseminated in an open or closed environment, and captured, originated and/or transmitted in specific geospatial locations (e.g., certain cities, countries, time zones, etc.). Thematic parameters may specify names, places, entities and events. By combining certain temporal, geospatial and thematic parameters in a Boolean manner in a gist concept, specific signatures may be created for ingested data to meet. In creating a gist concept, each parameter may be weighted differently, with weighting values received by a user via the user interface.

In step 303, parameters are received from one or more user input devices that define/identify one or more sensors. Sensors may include any source of data, such as a social media service, a digital news web site, etc., as already described herein. Sources may also include other sources, such as intelligence, surveillance and reconnaissance assets (e.g., human intelligence assets, satellite imagery, etc.). The source parameters may specify various aspects of the sensor, such as whether to acquire the data autonomously (e.g., by downloading from a website), or manually (e.g., by user input), and the means of acquiring data (e.g., URL's, access codes, etc.). Capabilities of certain sensors may also be identified by the parameters so that a user of MSDSS can readily determine the capability of using the sensor in the environment it is intended to be used. Examples of such parameters may include platform and sensor range and standoff capability, sensor timeliness, platform and sensor limitations with respect to whether and light, platform and sensor limitations with respect to terrain masking, and threats to a platform and sensor. Such parameters may be compared in various aspects to parameters describing the environment in which the sensor may be used as defined by a session and/or campaign (described below). Such environment parameters may include: range to target, time at which information is no longer of value, target characteristics, weather and/or lighting conditions, geography, and adversary activity.

In step 304, parameters are received from one or more user input devices that define one or more sessions. Session parameters form a data collection plan by identifying one or more sensors, and specific aspects of ingesting data from the specified sensors. For example, a session may specify times for acquiring data from a specific source/sensor.

In step 305, parameters are received from one or more user input devices that define one or more campaigns. The campaign parameters form an operational concept by identifying one or more of: 1) one or more gist concepts used to test ingested data, 2) one or more sensors from which to acquire the data, 3) one or more sessions to run to ingest the data.

In step 306, parameters are received from one or more user input devices that define the generation of one or more reports that are generated based on the results of running a campaign.

Once the case, gist concepts, sensors, sessions, campaigns, and reports are set, the ontology of the case is defined and MSDSS may run the case in steps 307 and 308. In step 307 social media service data and other data may be ingested (e.g., acquired over network 102 from one or more of the defined sensors according to the campaign parameters. This may include time sensitive real-time collection of open and closed source data. Ingestion of any open source server based data stream may be controlled via a human selection process and/or automatically feeding an analytic engine in MSDSS.

In step 308, the ingested data from the sensors is processed (e.g., compared, filtered, etc.) with the gist concepts to identify matches in which the ingested data corresponds to the gist concept parameters to within some threshold of correspondence.

From the gist matches, reports are generated in 309 according to the report rules. The generated reports may include lists and statistics of the gist hits, and may provide graphical identification of the gist matches geospatially on a map displayed for a user. Relationships and correlations between the different matches may be determined and displayed (e.g., by lines between the gist indicators). Step 309 may include receiving additional information from a user, such as textual notes and assigned values for each match or group of matches. Step 309 may further disseminate the reports to one or more users as defined by the report parameters. In disseminating the reports, step 309 may include having a report pulled by a user via a request or by access to the MSDSS, and/or may include pushing a report to a user unsolicited according to parameters defining the report (e.g., transmitting a report periodically to a predetermined one or more users).

Various aspect of an MSDSS may further provide interfaces for user's to remotely collaborate on the analysis of reports. Data and reports may be acquired/processed in an unsecure environment and may be transferred to a higher security environment via a secure login or authentication in order to provide collaboration with between users working in the different environment. The reports, along with feedback input into the MSDSS system from multiple users form the COP. One or more of the steps of process 300 may continue over a period of time such that data is continually and/or autonomously ingested and processed to generate/update reports in real time, thus presenting the users with a dynamically updated COP. From the evolving COP, users may better form a COA.

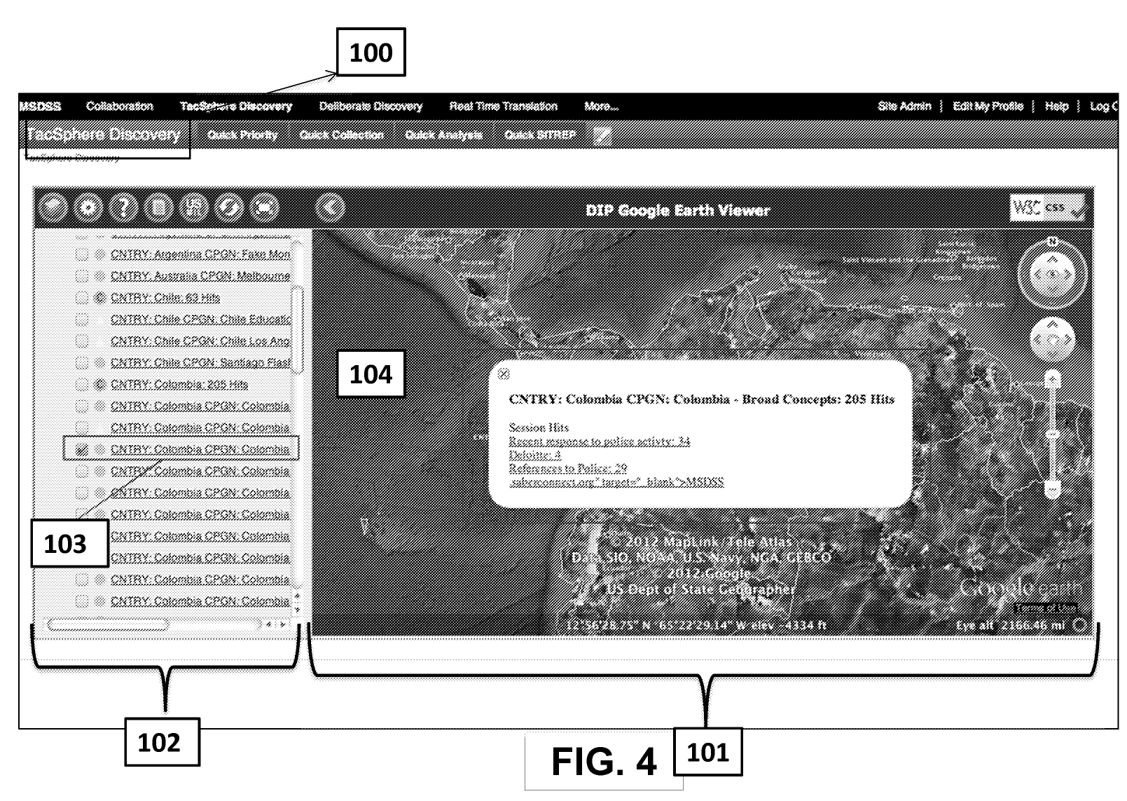

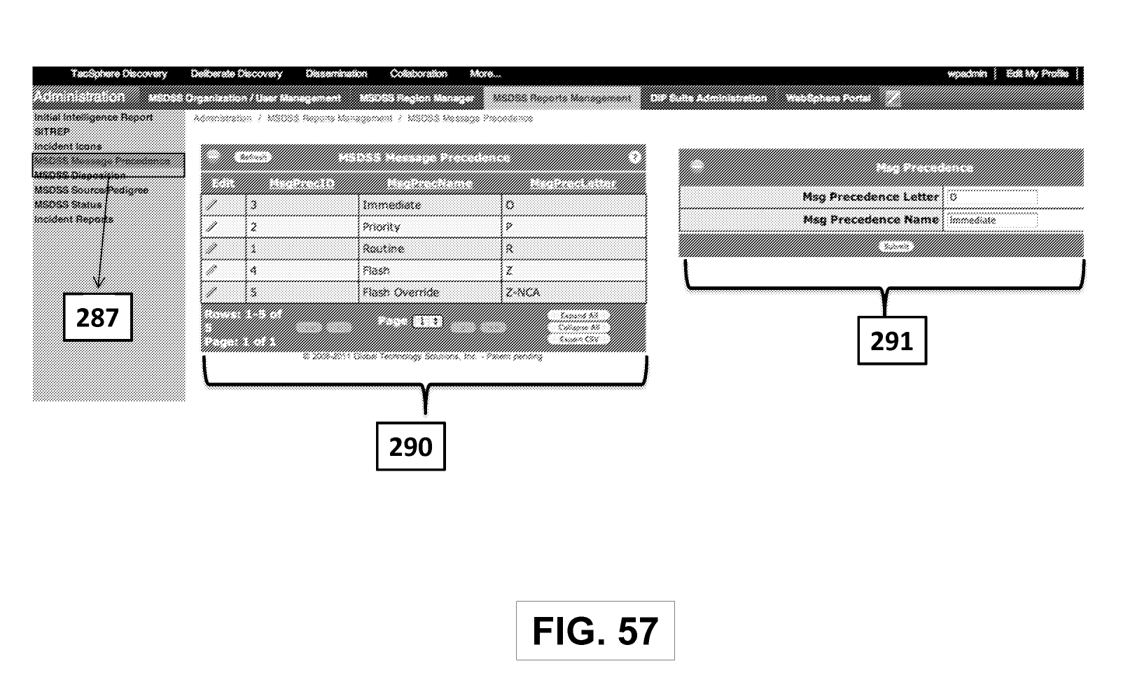

Each of the above steps may be performed, in various aspects with the use of a graphical user interface that enables a user to interact with the MSDSS. The graphical user interface may provide each different user with a user frame, that may be combined by MSDSS into one common organizational frame, in which multiple users at different locations view and share the same data. The user interface and further aspects of MSDSS are described below with respect to FIGS. 4-60.

FIGS. 4 illustrates a user interface (UI) according to various aspects that includes multiple selectable tabs, with each tab displaying a different view within the user interface when selected. Tab 100, labeled “TacSphere Discovery” when selected presents a window that graphical presents a geospatial representation of social data collected and stored within the memory of the system. UI 100 may include a map 101 having multiple presentation layers on which sessions may be geospatially identified.

The map 101 may include a topographical layer displaying ground contour and one or more additional layers displaying, for example: country borders; country and city labels; latitude, longitude, and elevation of a specific point on the map; labeling identifying a source of the map data, etc. Within map 101, a layer may also present a label “104” identifying a location in the map associated with a session. An overlay window associated with a session label may be presented that displays data associated with the session, which may include a session report that lists session hits (e.g., ingest data that matches a gist concept). Map 100 may have displayed controls (e.g., buttons, icons, etc.) for manipulating the map display, such as orienting the map in a particular direction (e.g., north), zooming, or traversing the map (e.g., left, right, up, down).

UI 100 may also include a scrollable window displaying an assembly list of reports on particular operating sessions within a case. Each report 103 may be selectable to display data associated with the report on the map (e.g., 104). The session reports may be arranged in different manners, such as listing the reports in alphabetical order by country of origin.

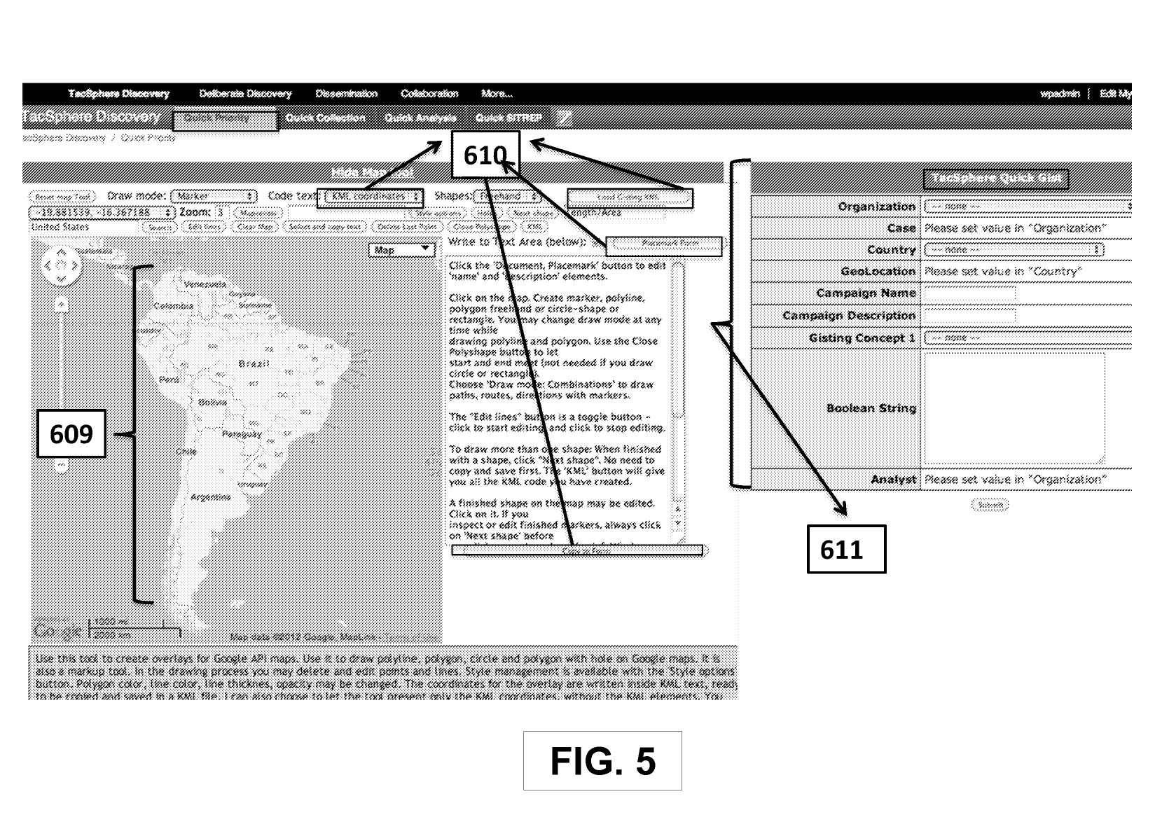

FIG. 5 illustrates another window within the user interface when a tab labeled “TacSphere Discovery” is selected and when a “Quick Priority” tab within the TacSphere Discovery window is selected. The window may include an interactive map 609 used for drawing a session label overlay on the map with a mapping tool for autonomously generating Keyhole Markup Language (KML) or other language that can be copied to a form and shared for collaboration. The interface in FIG. 5 may include one or more specific tools 610 for plotting the overlay on the map and copying the KML to the form for collaboration. The interface may further include a form 611 for assembling a gist concept (e.g., a Boolean search string) associated with a session label overlay.

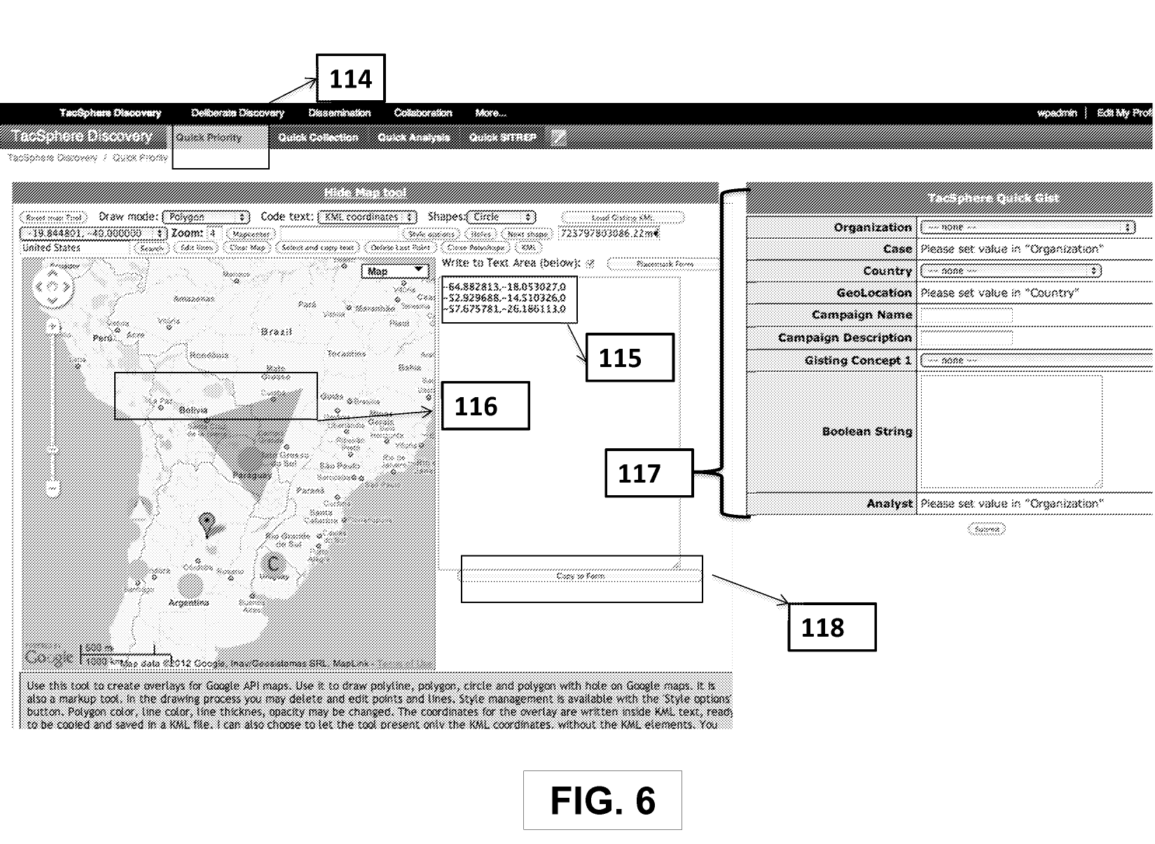

FIG. 6 illustrates another view of the window illustrated in FIG. 5. When a user selects an area on the map 609 with the mapping tool, geospatial coordinates may be auto populated in a form. The coordinates can be dragged into other forms by the user. Within the interactive map 609, graphics may be displayed that are associated with gist concepts, pin dropping, and shape drawing in order to capture the geospatial KML codes. Form 117 is the same as 611 described previously, which may be used to hastily establish a gist concept while still maintaining integrity in the reporting requirements. A radio button 118 may be used to copy the contents of the form (e.g., 115) for dissemination to an organization

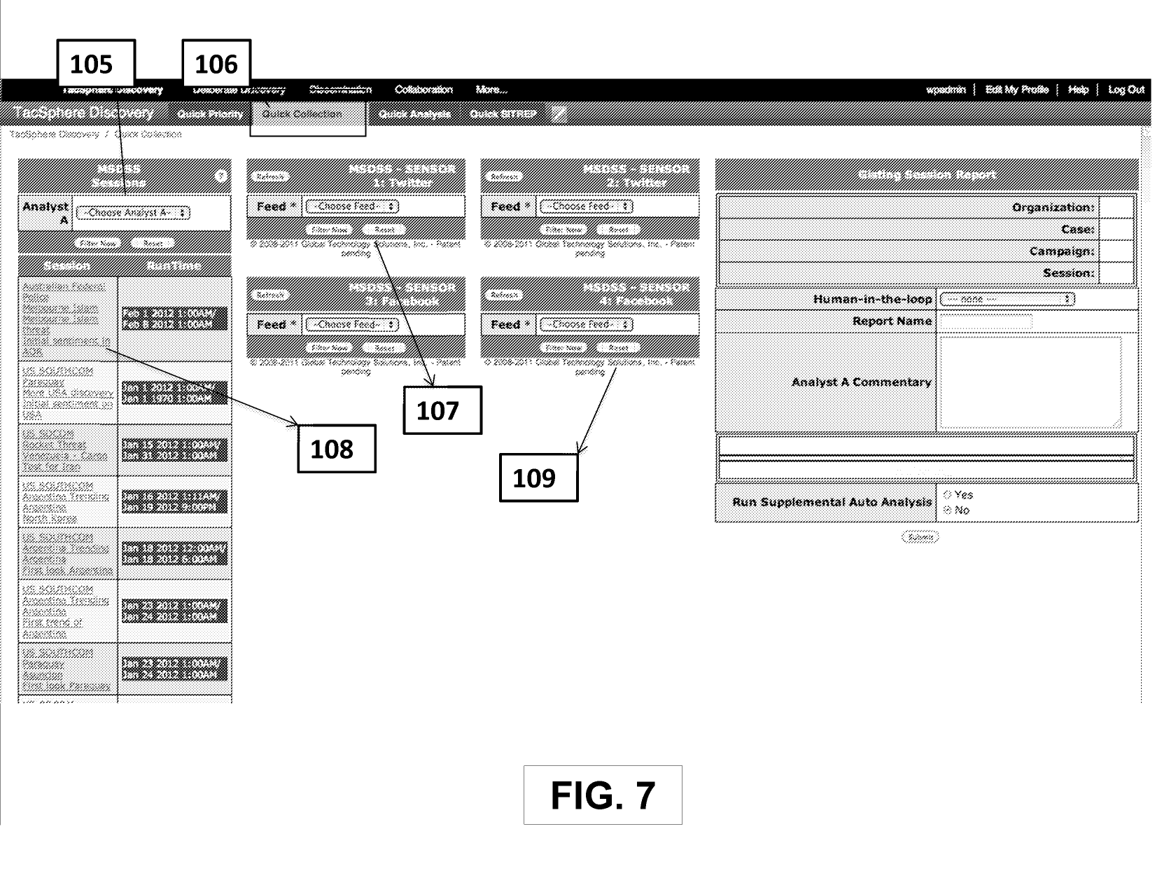

FIG. 7 illustrates another window within the user interface when a tab 106 labeled “Quick Collection” is selected. The Quick Collection window may include a window listing MSDSS sessions, one or more windows listing, one or more MSDSS sensors, respectively, and a session report window. The MSDSS sessions window may include a drop down window 105 used to select a user's name from which to filter the list of sessions. Each listed session 108 may be selectable in order to show sensors (e.g., 107 and 109) associated with the selected session. Each MSDSS sensor window 107 and 109 may specify a particular sensor and may include a feed selection window from which to select a gist concept with which to filter data ingested from the sensor. The gist concept may include, for example, a Boolean string of words to filter the ingested data with. The Quick Collection window may also include a session report window for entering a report associated with a session.

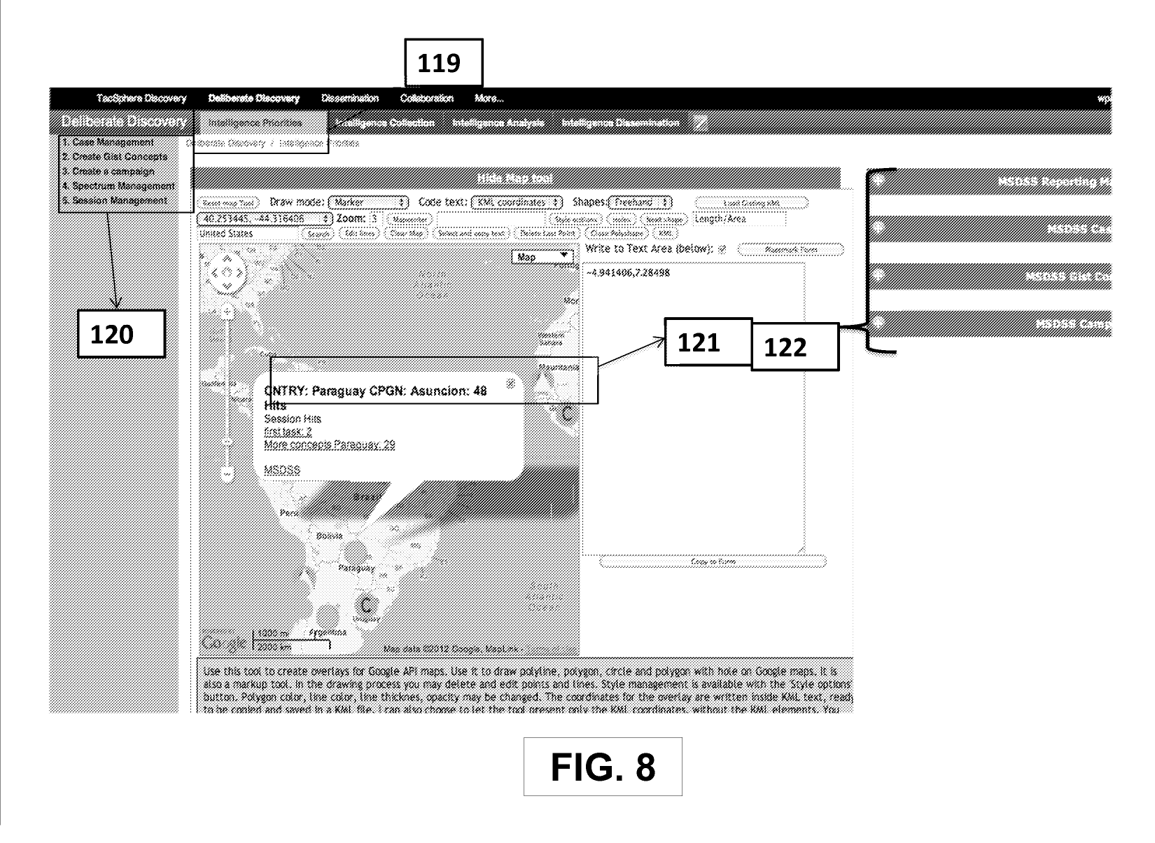

FIG. 8 illustrates a window within the user interface when the tab labeled “Deliberate Discovery” is selected and when an Intelligence Priorities tab 119 is selected within the Deliberate Discovery window. The window enables users to establish an intelligence gathering process based on the process of FIG. 3 by having selectable tabs 112 for creating, respectively, a case, gist concepts, campaigns, and sessions, and for selecting sensors (e.g., spectrum). By clicking on icons 121 plotted on the map the user can view the social data arranged by country. This will open a call out window, which shows all the gist concept results for the country (or other geospatial area). The window further includes forms 122, which may be expanded and collapsed, and which correspond respectively to the tabs 120. These forms are consistent with the matrix of a specific organization and ensure that levels of supervision and reporting are constant with organizational constraints.

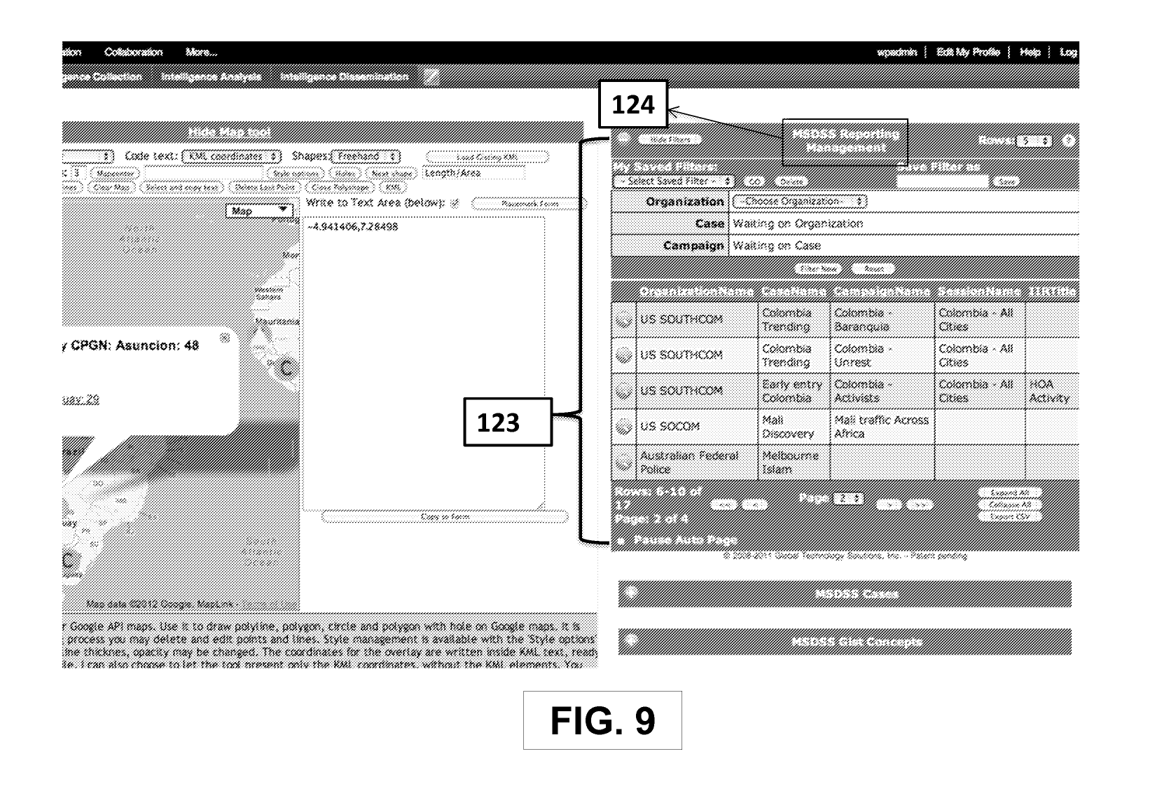

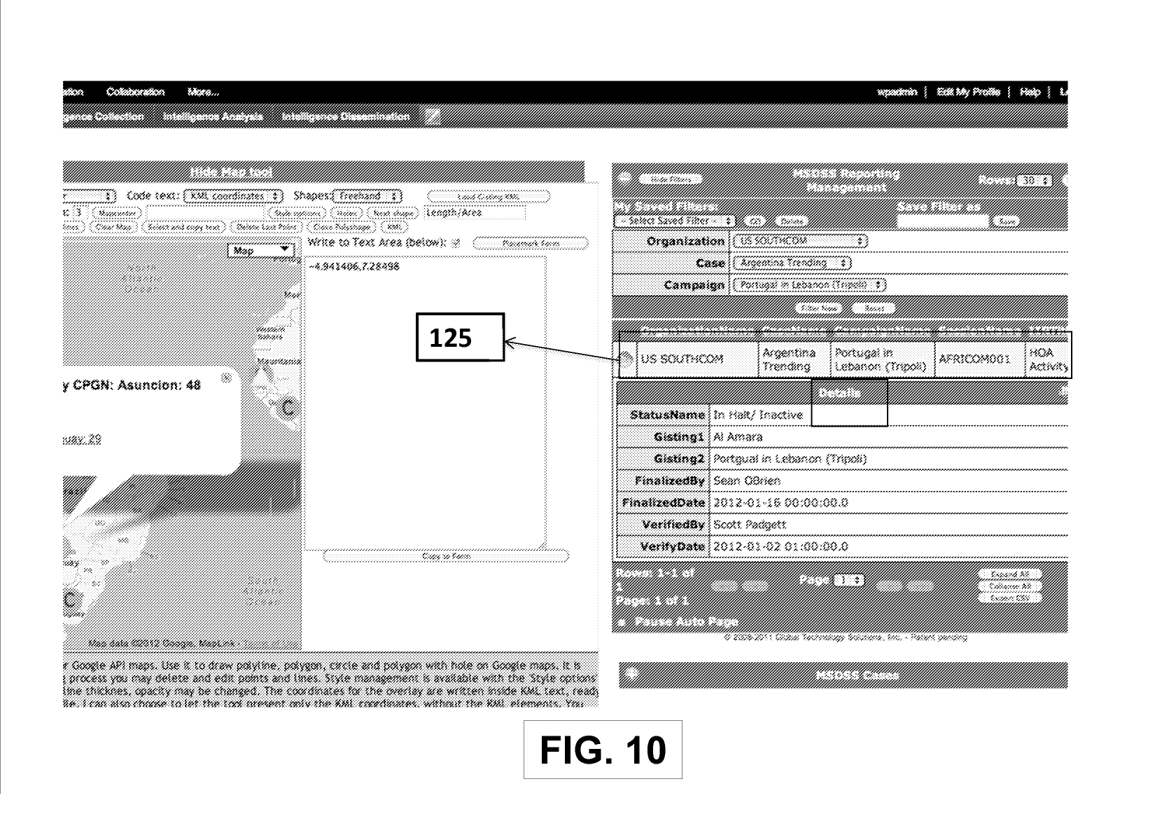

FIG. 9 illustrates the window of FIG. 8 within the user interface when one of the forms 122 is expanded to display an expanded form 123. Heading 124 identifies the name of the expanded form (e.g., MSDSS Reporting Management”). Expanded form 123 shows a list of workflows for which the user is responsible, with the organization, case campaign, session and report associated with each workflow listed. The organization, case, campaign, session and report are identified and can be selected for expansion as illustrated in FIG. 10.

FIG. 10 illustrates the same window as FIG. 9, but with a radio button selected next to a particular workflow within form 123 selected. When the button is selected, an expansion window 125 is displayed to show details of the work flow.

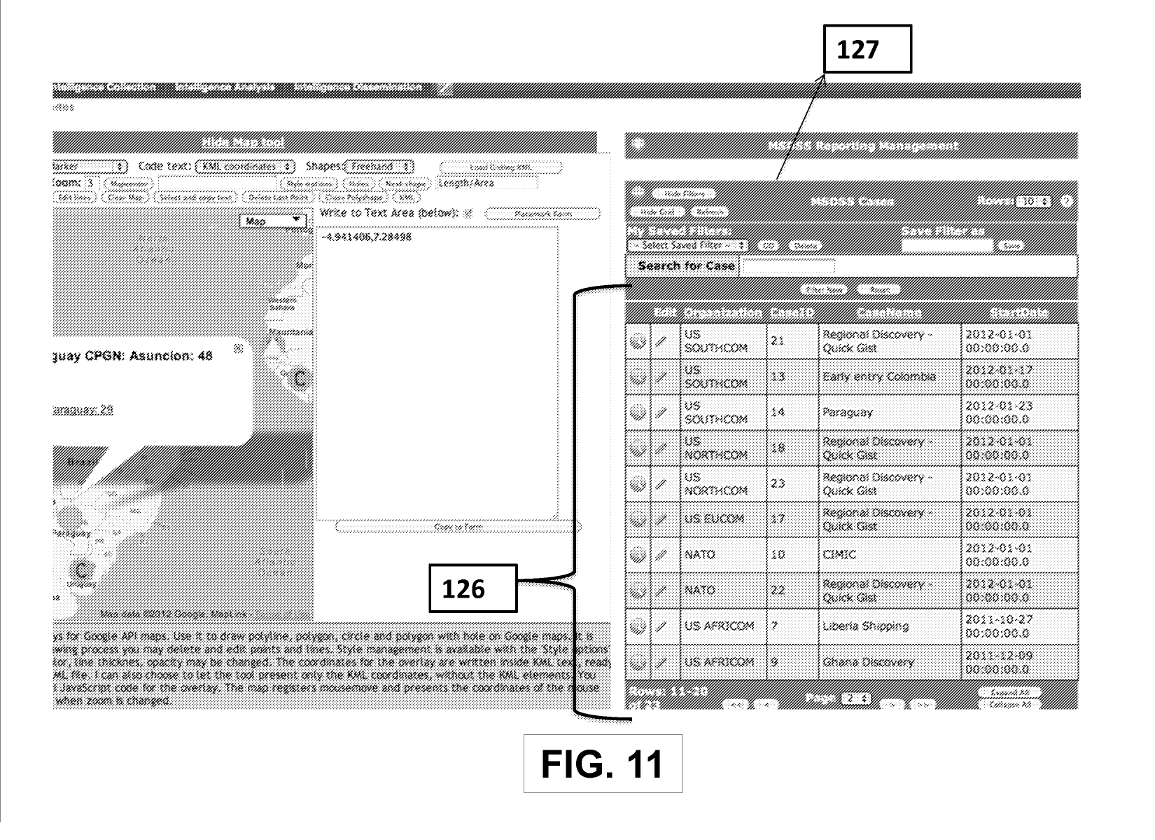

FIG. 11 illustrates the window of FIG. 8 with expanded form “MSDSS cases” displayed. The expanded form may include a list 126 of organizational cases arranged in case ID order in order to give structure and reporting functionality. The expanded form may include a form field 127, which provides user functionality is searching for organizational case data.

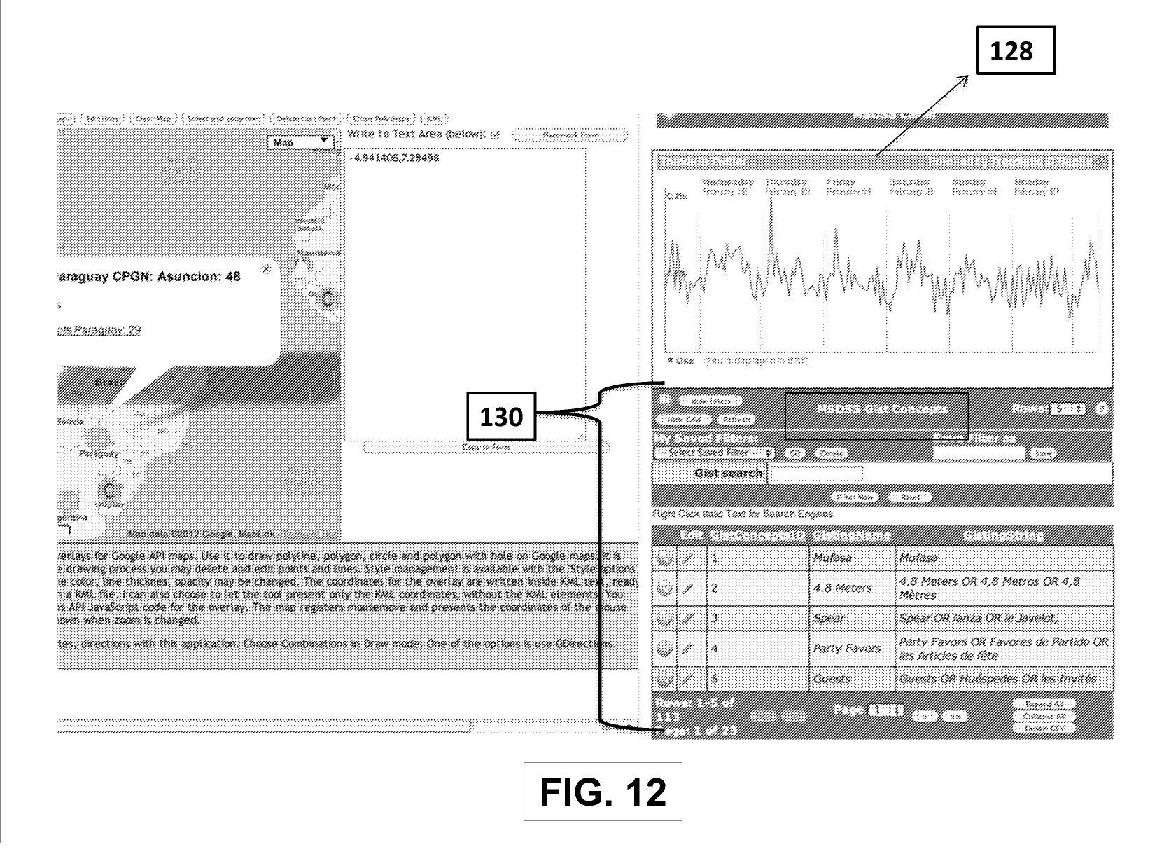

FIG. 12 illustrates the window of FIG. 8 with expanded form “MSDSS gist Concepts” displayed. The expanded form may include a trend map 128 showing trends of hits (e.g., matches of ingested data to a gist concept. The trend map provides a quick visualization of current gist concepts. The expanded form may further include another form 130, which arranges all the gist concepts in rows by an ID# and allows the user to edit and expand the row to reveal details or a particular gist concept.

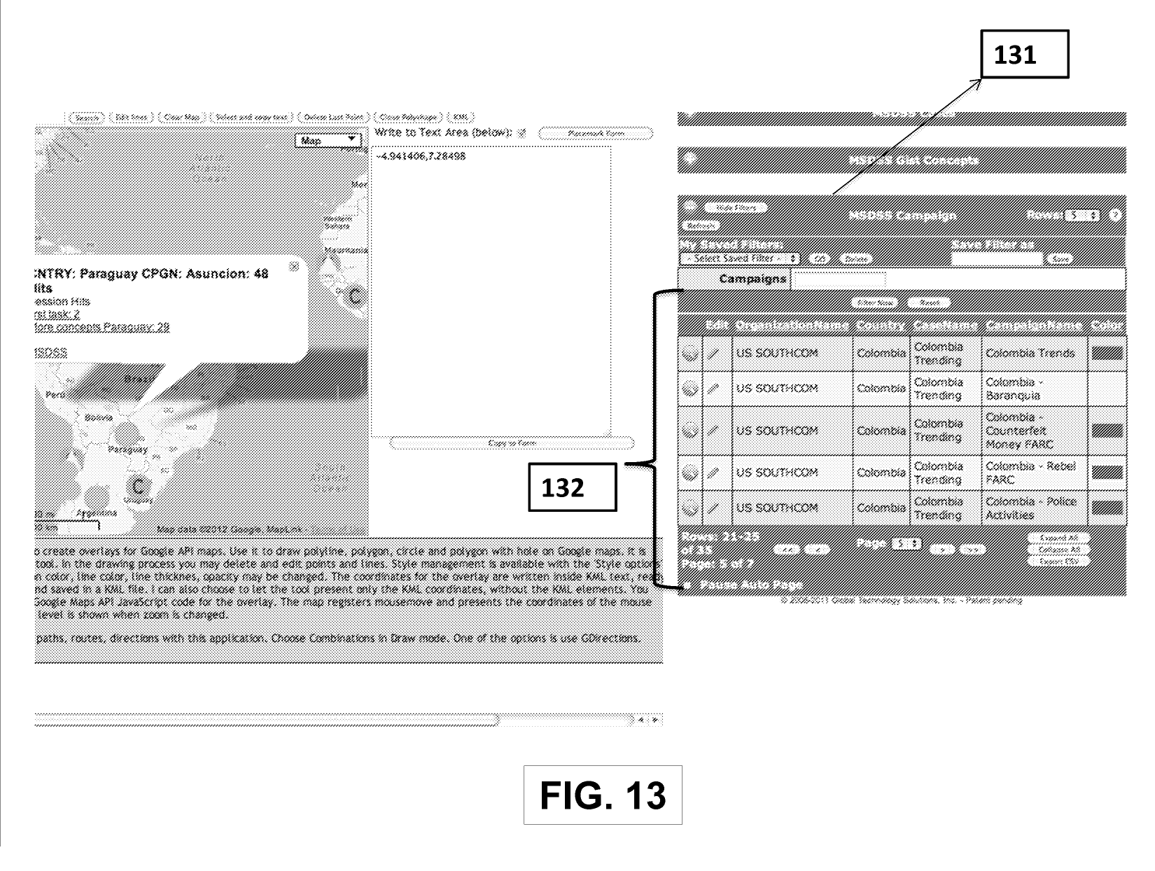

FIG. 13 illustrates the window of FIG. 8 with expanded form “MSDSS Campaign” displayed. The expanded form may include a form 131, which enables a user to search for a particular campaign listed in the table 132. Table 132 may arrange the campaign by organization and country. Each row in table 132 may include an associated color code to alert the user of pending deadlines and status of the campaign.

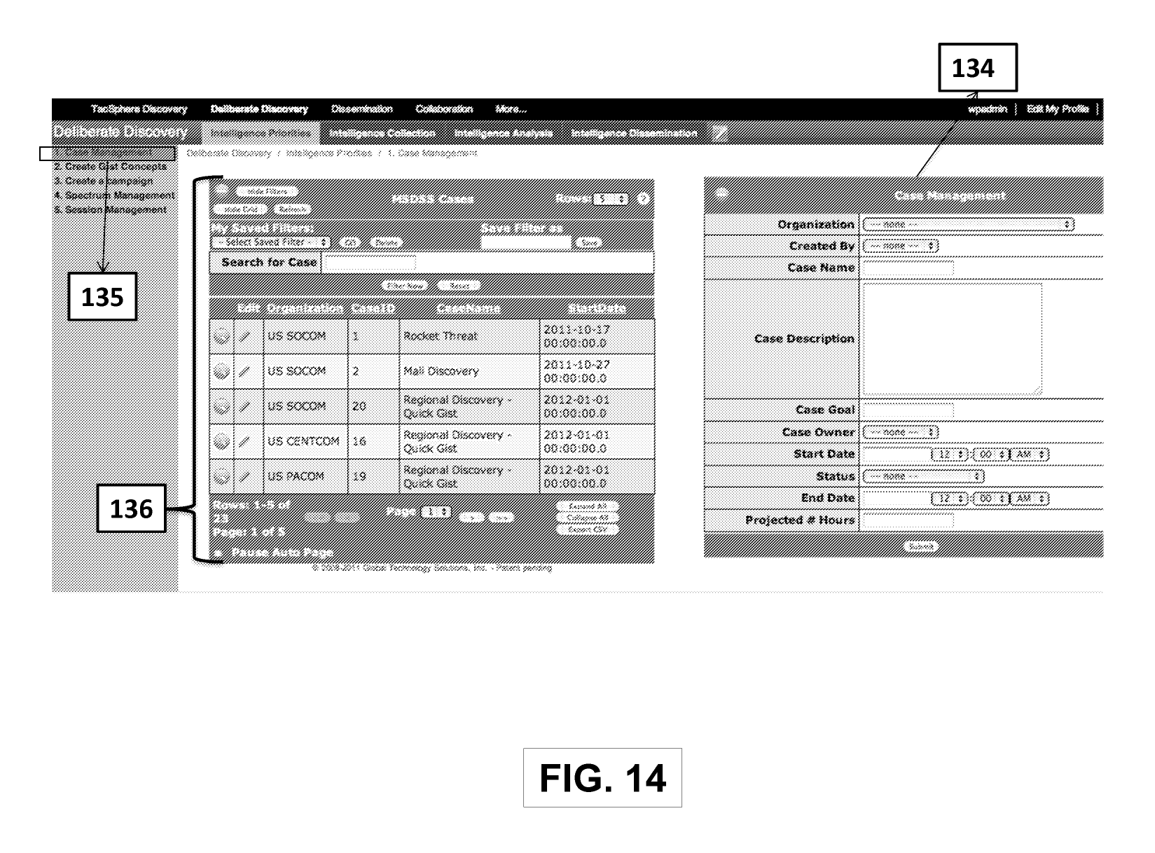

FIG. 14 illustrates the window of FIG. 8, when the “Case Management” tab 135 within tabs 120 is selected. This window may include form 136 that enables a user to arrange current cases. Selectable rows within form 136 may be used to auto populate the adjacent form and/or the rows may be expanded to reveal additional details about a listed case. The adjacent form 134 provides additional details for a case selected in form 136, and in some examples, may auto populate if a case is selected from the adjacent window. Form 134 may further/alternately include drop down and Tillable windows to populate the form for creating a new case. Form 134 may include a button (e.g., a Submit button) to create a new case based on the populated data.

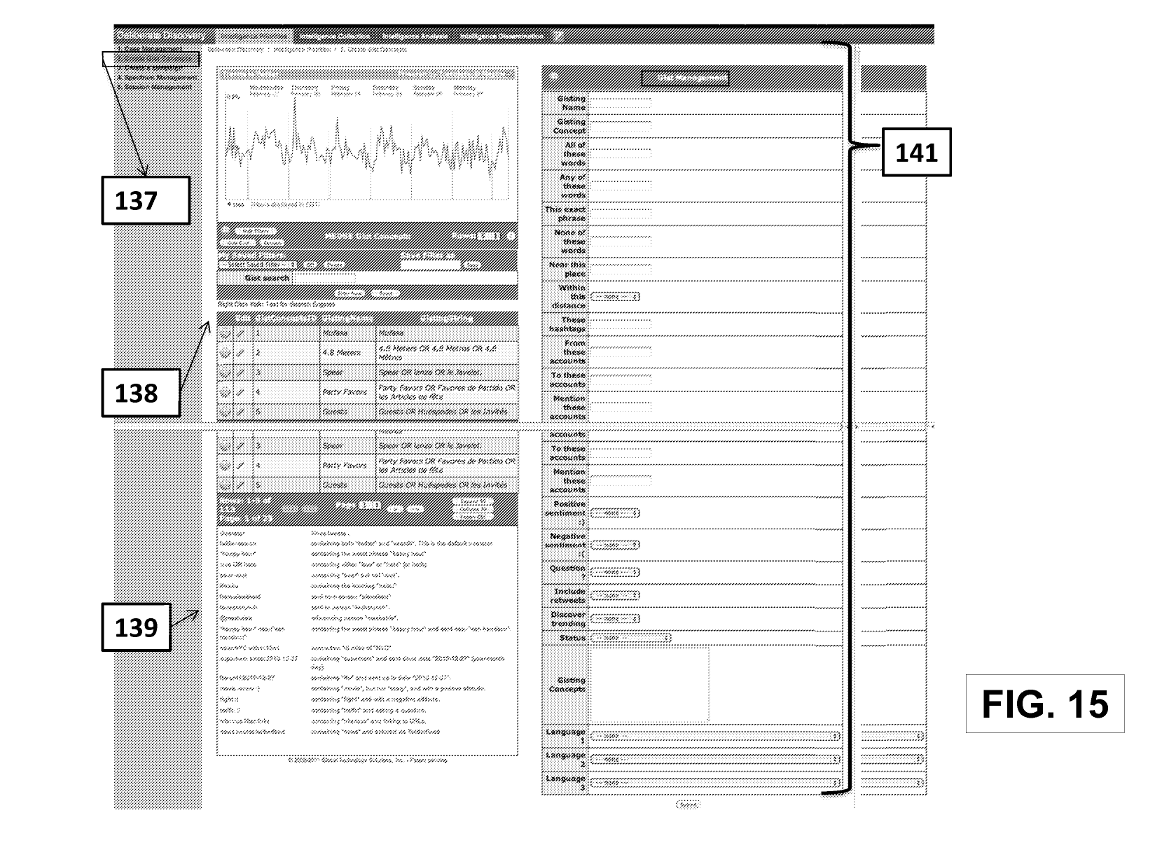

FIG. 15 illustrates the window of FIG. 8, when the “Create Gist Concepts” tab 137 within tabs 120 is selected. In this configuration, the window enables the user to manipulate current gist concepts. This window may include form 138, which arranges the gist concepts in rows (e.g., in numerical order). A row within form 138, in some examples, may be selected to auto populate an adjacent form 141, and/or the rows may be expanded to reveal additional details about a listed case. The window may further include a form 139, which is a quick reference form for listing gist string components that may be used in building gist strings (e.g., Boolean sentences).

Form 141 may be auto populated from selecting a row in adjacent window 138, and/or the user can enter specific data into fields in form 141 to build a gist concept as well as choose from a series of drop down windows to answer simple questions (e.g., language, sentiments, etc.). Form 141 may include a button (e.g., a Submit button) to create a new gist concept based on the populated data.

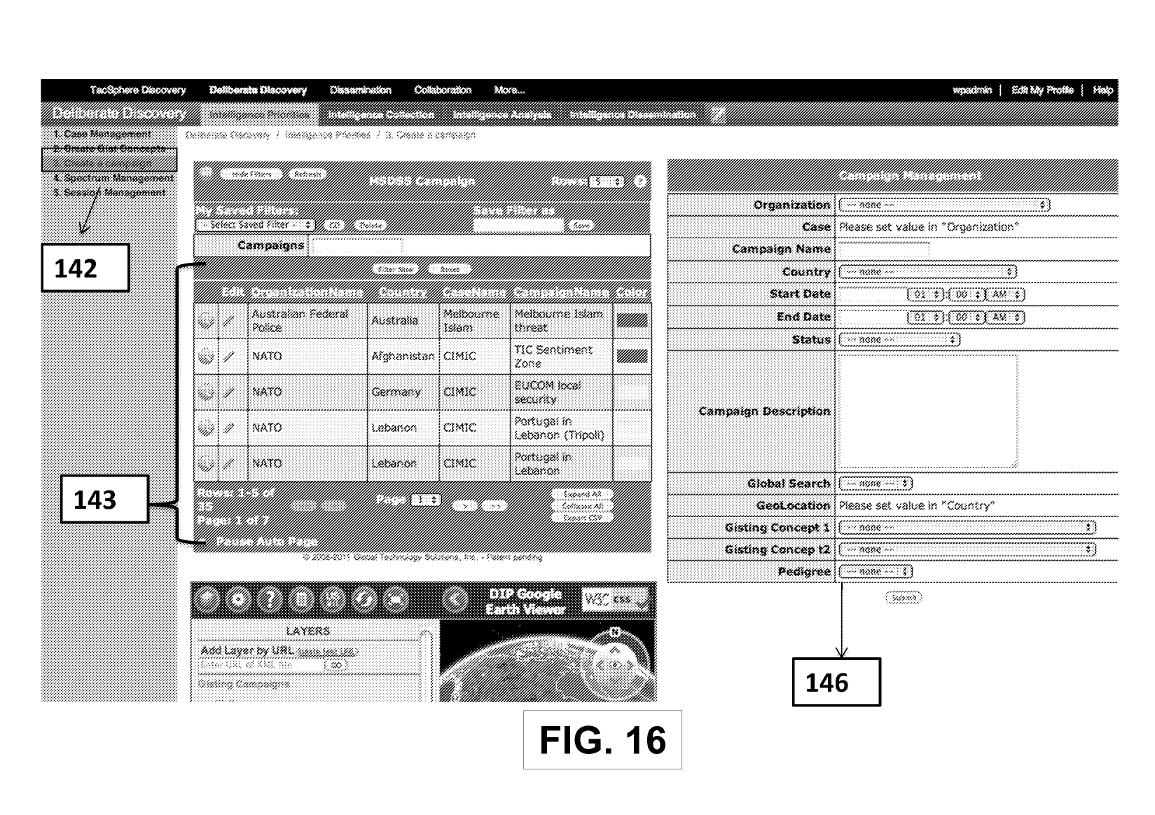

FIG. 16 illustrates the window of FIG. 8, when the “Create a Campaign” tab 142 within tabs 120 is selected. In this configuration, the window enables the user to manage campaigns. This window may include form 143, which allows the user to select existing campaigns listed in rows to edit details about the selected campaign. Each row may be color coded to indicate status of the campaign. A row within form 143, in some examples, may be selected to auto populate an adjacent form 146, and/or the rows may be expanded to reveal additional details about a listed campaign.

Form 146 may be auto populated from selecting a row in adjacent window 143, and/or the user can enter specific data into fields and/or choose from a series of drop down windows to answer simple questions in form 146 to build a campaign Form 146 may include a button (e.g., a Submit button) to create a new campaign based on the populated data. Within form 146, quantities and quality of effort of the campaign may be managed.

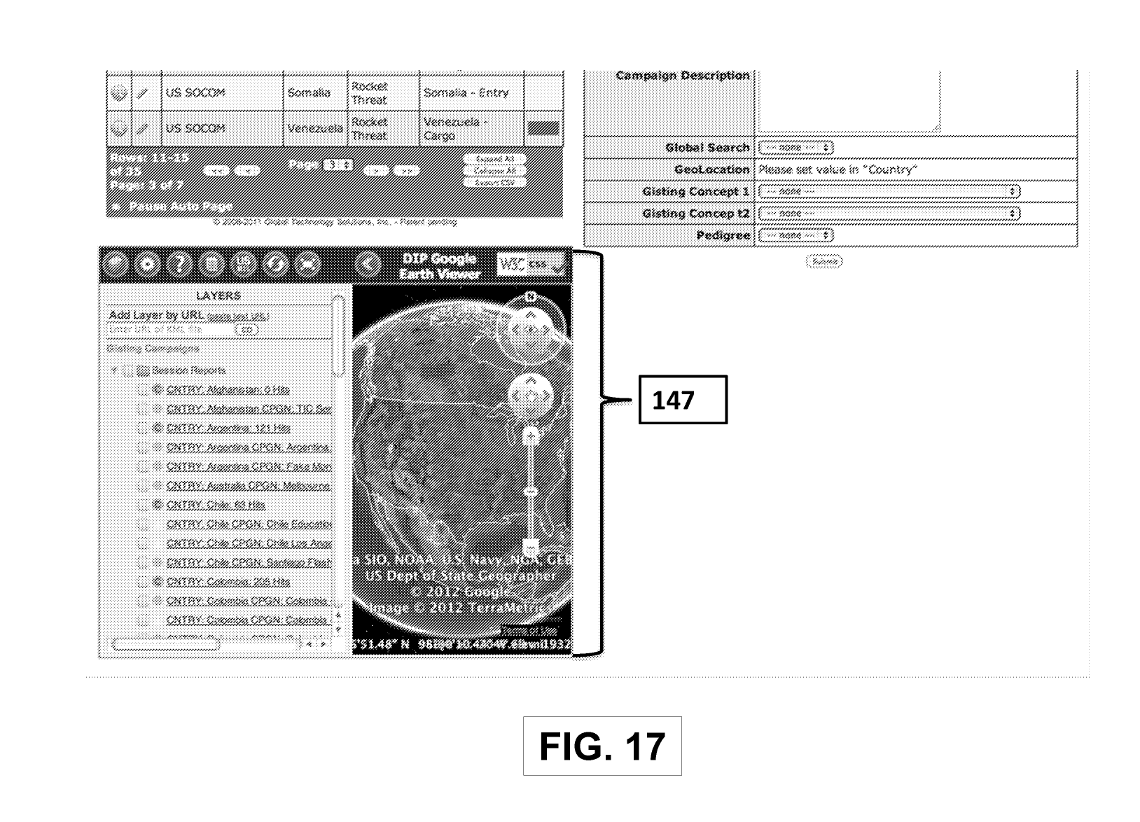

FIG. 17 illustrates a bottom portion of the window displayed in FIG. 16, and includes a window 147 that displays an interactive map on which current sessions may be plotted while in the Create a Campaign window. Window 147 includes a selectable list of sessions, which may be displayed in the map.

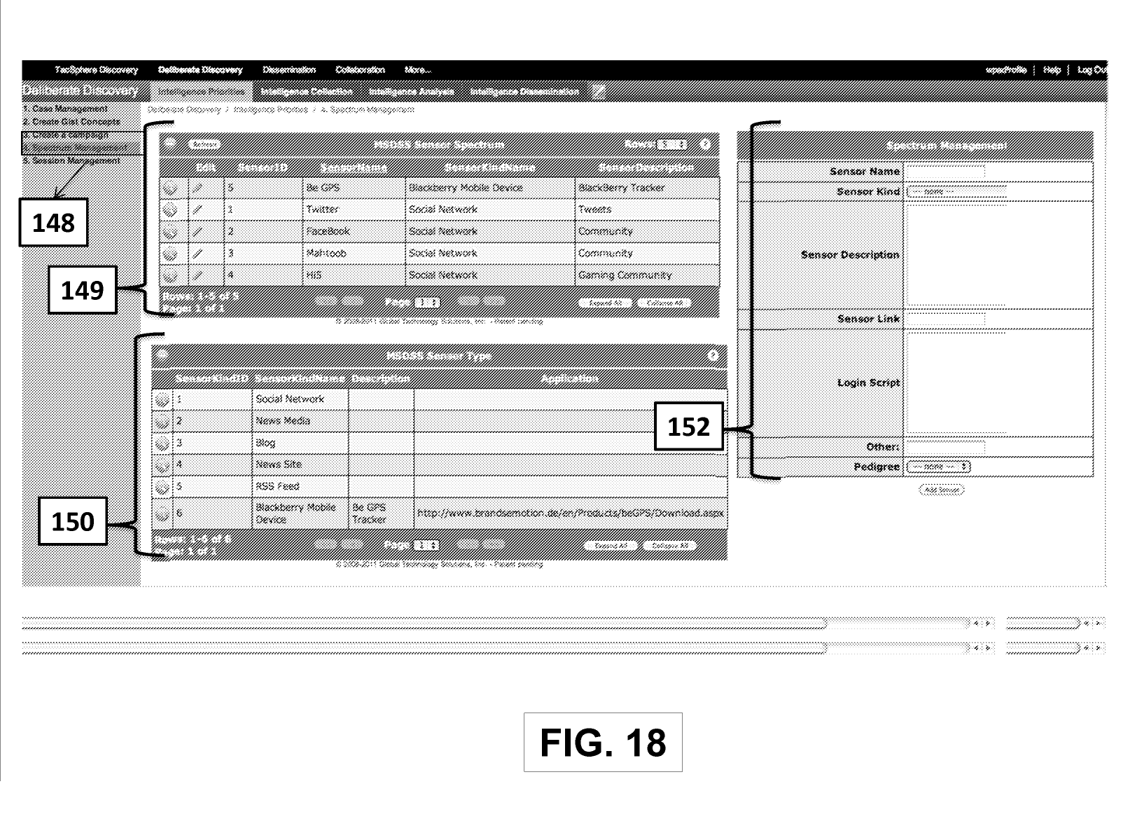

FIG. 18 illustrates the window of FIG. 8, when the “Spectrum Management” tab 148 within tabs 120 is selected. In this configuration, the window enables the user to manage, select, edit, and create a new sensor. This window may include form 149, which allows the user to select, edit and manage current sensors arranged in rows by sensor name and ID#. Form 150 within this window may be used to collect and pass on information about each sensor, nuances, special instructions etc.

A row within forms 149 and 150, in some examples, may be selected to auto populate an adjacent form 152, and/or the rows in each form may be expanded to reveal additional details about expanded row.

Form 152 may be auto populated from selecting rows in adjacent forms 149, and 150, and/or the user can enter specific data into fields and/or choose from a series of drop down windows to answer simple questions in form 152 to build a create a new sensor. Form 152 may include a button (e.g., Add Sensor button) to create a new sensor based on the populated data.

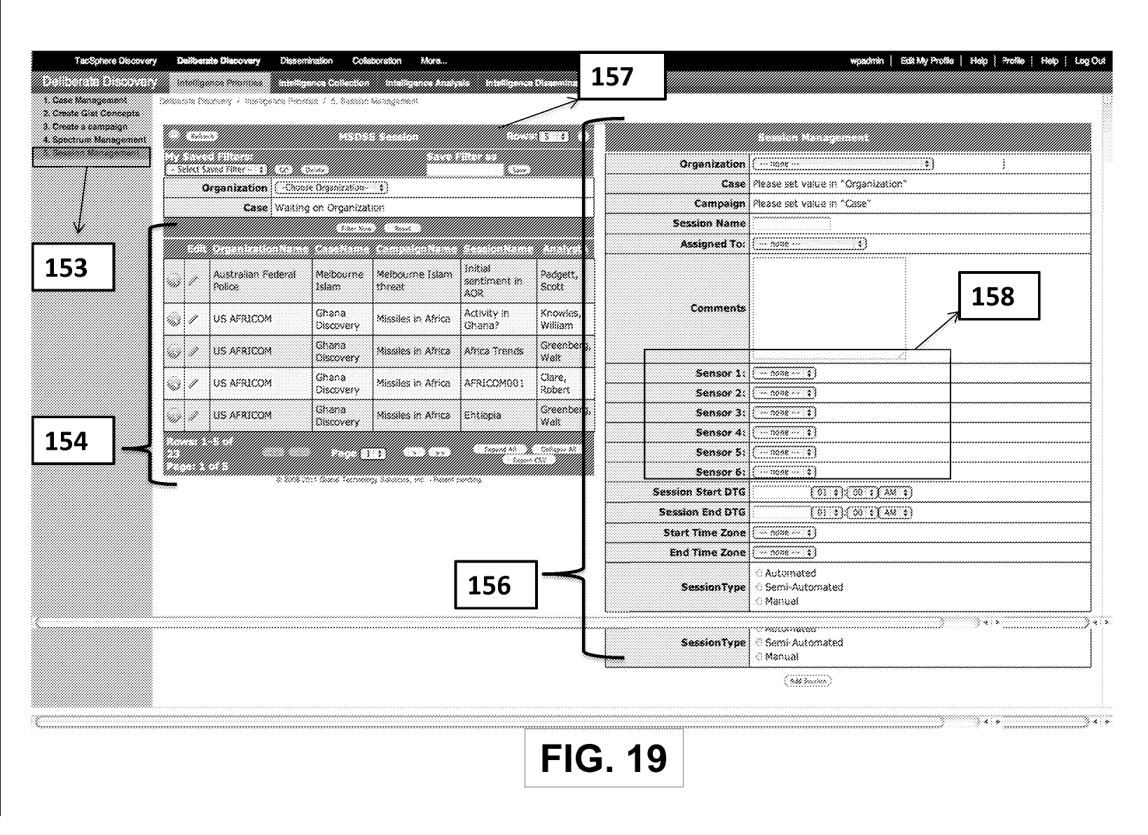

FIG. 19 illustrates the window of FIG. 8, when the “Session Management” tab 153 within tabs 120 is selected. In this configuration, the window enables the user to manage sessions. This Session Management window may include form 154, which arranges the sessions in rows and may identify a responsible individual for the session. Header form 157 allows user to quickly search form 154. Form 156 within the window enables a user (e.g., a supervisor of an organization) to create sessions, assign dates (e.g., start and end dates), session type (e.g., automated, semi-automated, manual), add comments, and assign the session to a particular user. Within form 156, form 158 includes options for managing (e.g., using or not using) particular sensors, setting the quantity of data from each sensor, and the amount of time using the sensor. Form 156 may include a button (e.g., an Add Session button) to create a new session based on the populated data within form 156.

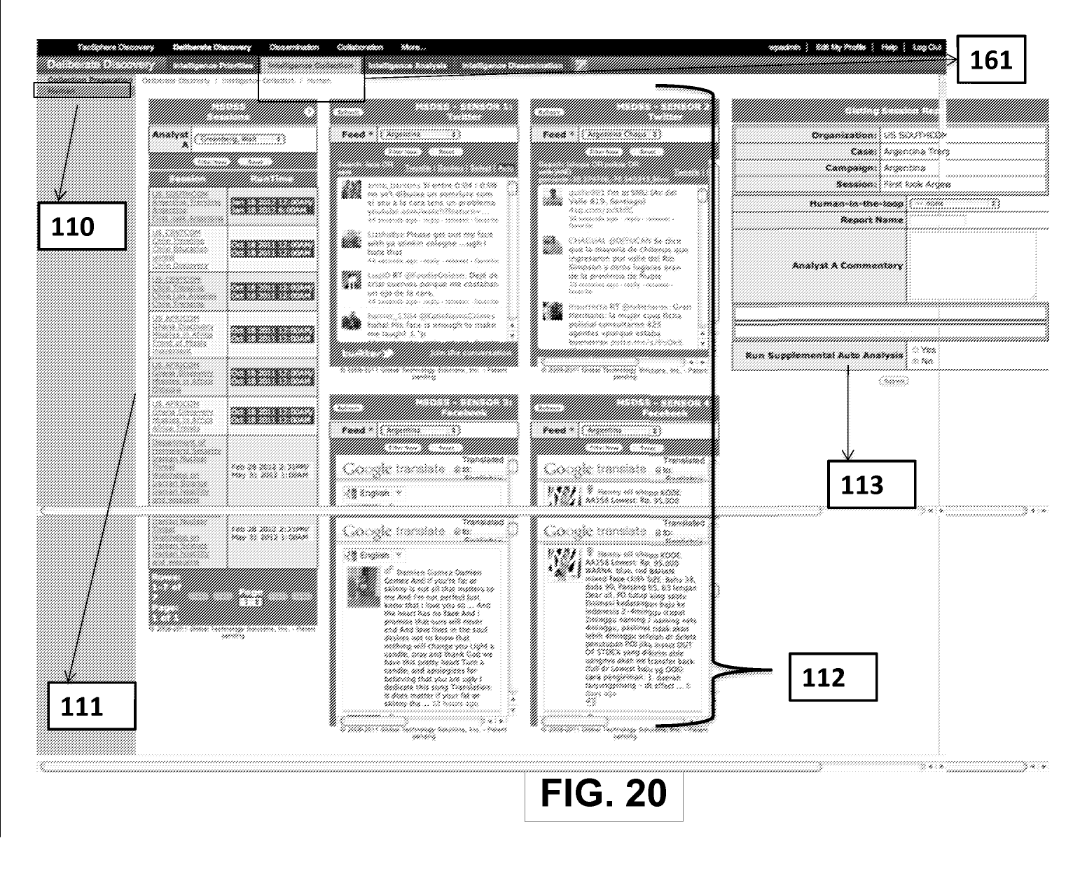

FIG. 20 illustrates another window within the user interface when a tab labeled “Deliberate Discovery” is selected and when an Intelligence Collection tab 161 is selected and when a Humans tab 110 within the Intelligence Collection window is selected. Within the window, sessions may be launched (e.g., started) to ingest data from sensors and filter the data against gist concepts. The Deliberate Discovery window may include a window listing MSDSS sessions 111, one or more windows listing one or more MSDSS sensors 112, respectively, and a session report window 113. The MSDSS sessions window 111 may include a drop down window labeled “Analyst A,” which may be used to select a user's name from which to filter the list of sessions. A status of each listed session within window 111 may be color coded to indicate a status of the session. Each listed session may be selectable in order to show sensors (e.g., 112) associated with the selected session. Each MSDSS sensor window 112 may specify a particular sensor and may include a Feed selection window from which to select a gist concept with which to filter data ingested from the sensor. Each sensor Window may include a display of the ingested data from the sensor.

The gist concept (e.g., a Boolean string of words to filter the ingested data with) may be displayed in the sensor window. The Deliberate Discovery/Intelligence Collection/Human window may also include a Session Report form window 113 which enables a user to describe the setting and make comments on a discovery (e.g., a match between ingest data and the gist concept).

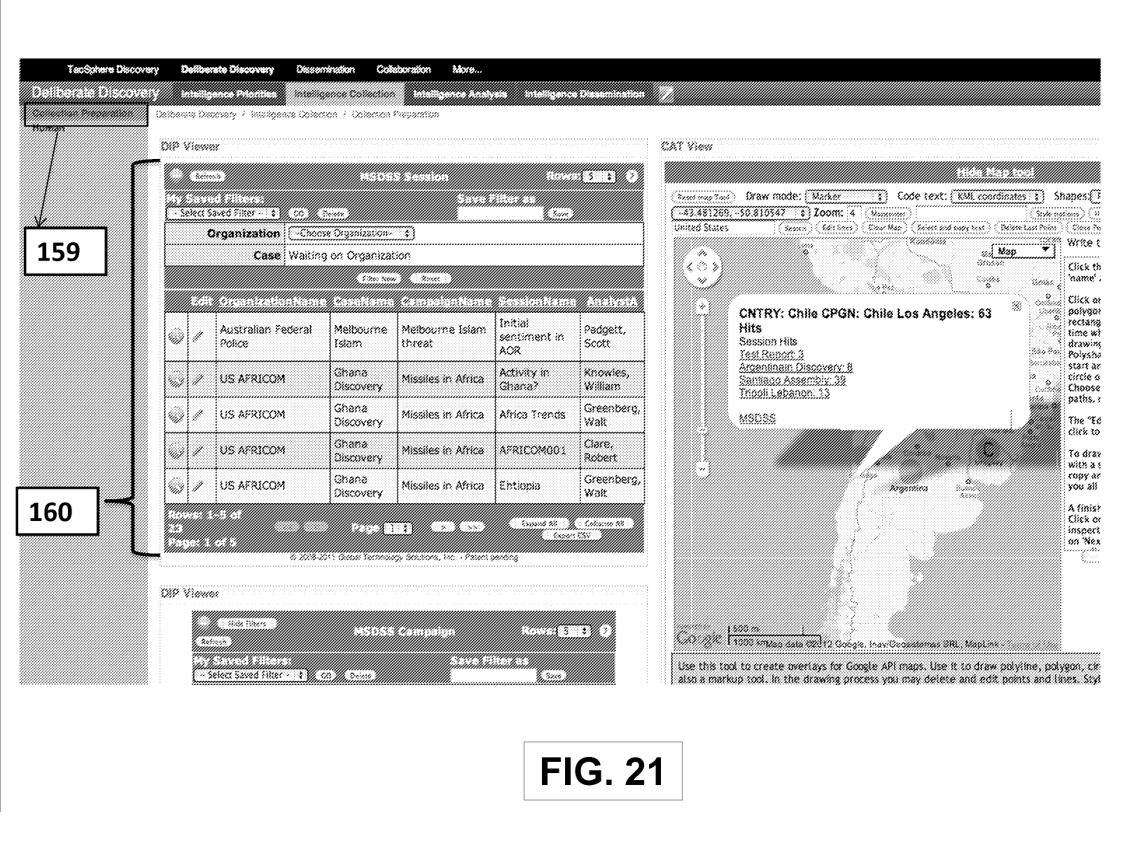

FIG. 21 illustrates the Deliberate Discovery/Intelligence Collection 161 window when a Collection Preparation tab is selected which enables users to manage a collection phase of an operation. In this mode, the window assembles (e.g., displays in one or more forms) and enables modification of data points (e.g., sessions) users have already established. Form 160 enables users (e.g., a supervisor with a team) to collaborate on a session while it is in progress (e.g., collecting and processing data) as well as compare the session to a geospatial representation illustrated on an annotated map.

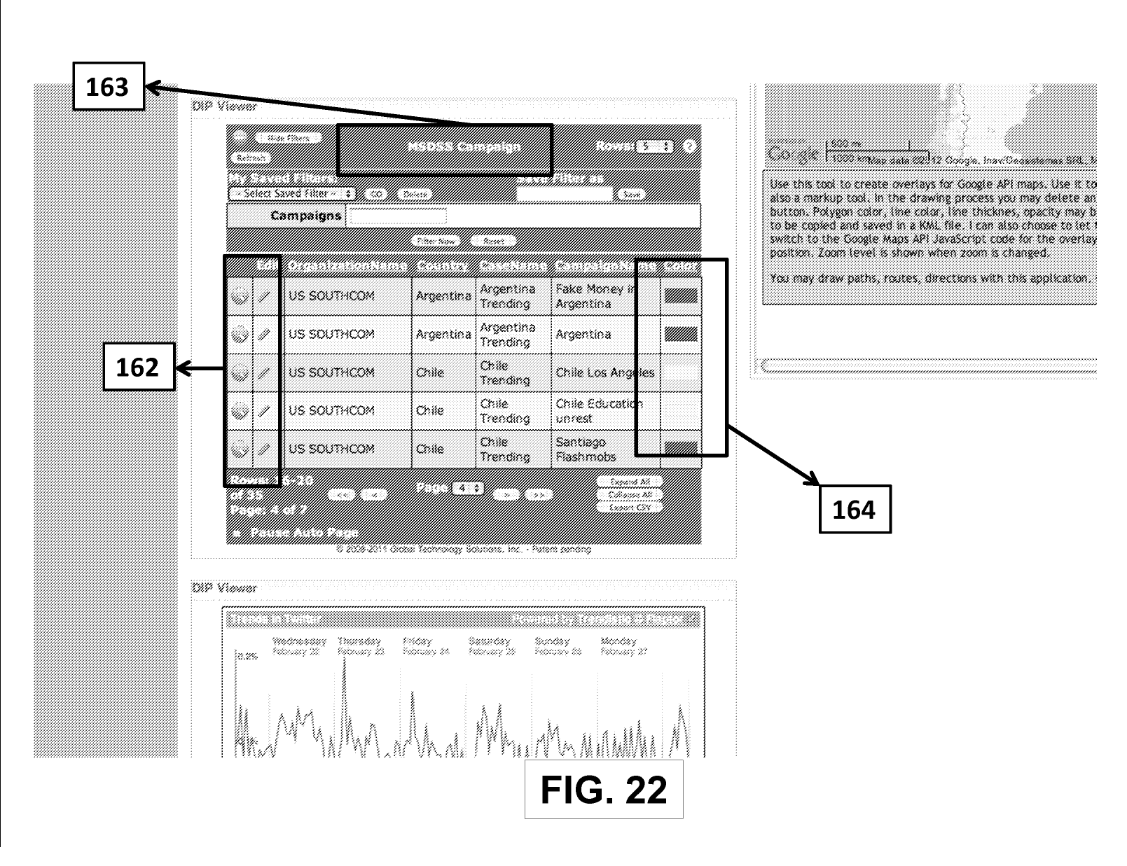

FIG. 22 illustrates details of a MSDSS campaign form within the window of FIG. 21. Within the MSDSS campaign form, a form title and heading bar 163 may be included to orients the user and allow for quick search of campaigns. Each campaign may be listed in rows within form 160, and each row may be expandable by, for example, selecting icons 162 within the rows. Each row may further include color codes 164, which indicate whether is on schedule, behind schedule or pending action. The MSDSS campaign form may be the same as form 132 in FIG. 13

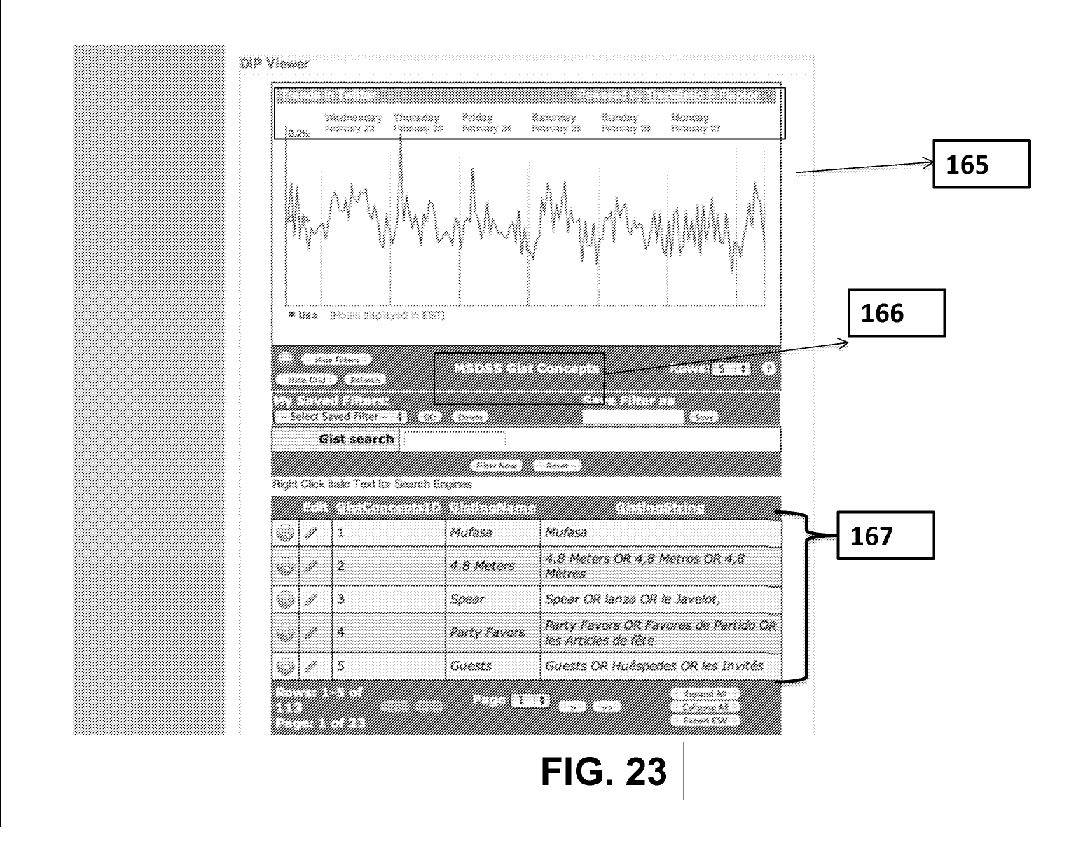

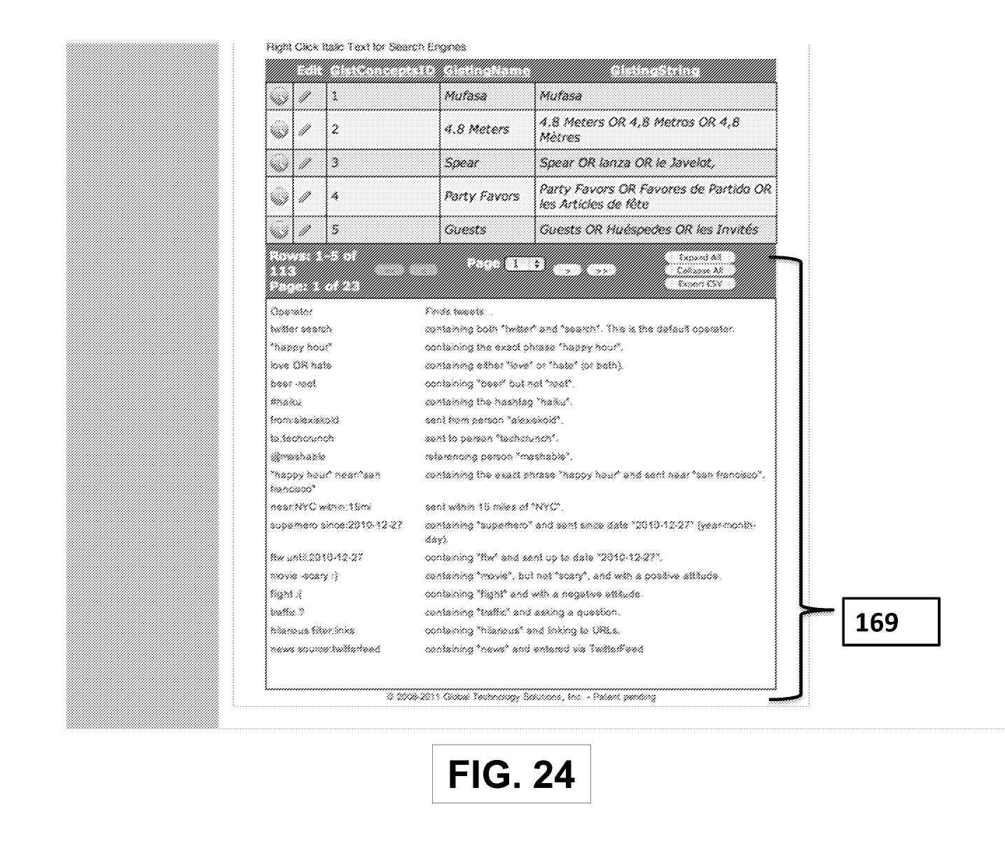

FIGS. 23 and 24 illustrate details of additional forms within the window of FIG. 21. Form 165 may include a trend map showing trending of ingested data in relationship to a current gist concept in the queue (e.g., matches of ingested data to a gist concept). A MSDSS gist concepts form may also be included in the FIG. 21 window. The MSDSS gist concepts form may include a Heading/Title 166 to orient the user on the form and allow user to quickly search for specific gist concepts. The MSDSS gist concept form that enables multiple users to collaborate, make modifications, and make comments on gist concepts, which are listed in rows 167 by an ID number with other gist concept details. FIG. 24 further illustrates a quick reference form for listing gist string components that may be used in building gist strings (e.g., Boolean sentences).

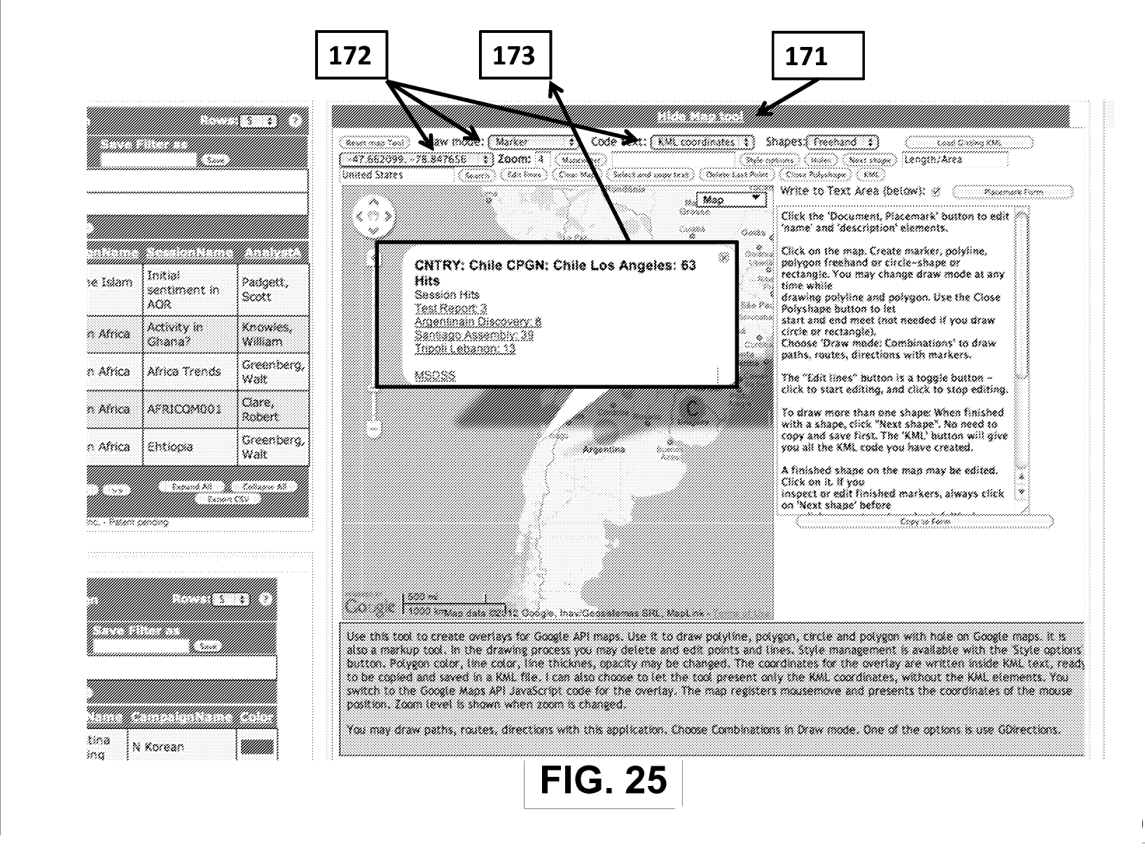

FIG. 25 illustrates a map form 171 within the window of FIG. 21. The map within the map form displays graphically current campaign running and the status of those campaigns (e.g., amount of ingested data matching gist concepts). The map may include a geospatial representation of each campaign running. For a campaign, a call out form 173 may be presented to present the gist concepts with social data ingestion and the geospatial plots. The call out form 173 may include selectable links to present exact social identifications. The map form 171 may also include one or more map tools (e.g., Geo Code, Drawing tool, Type of code text to view, etc.).

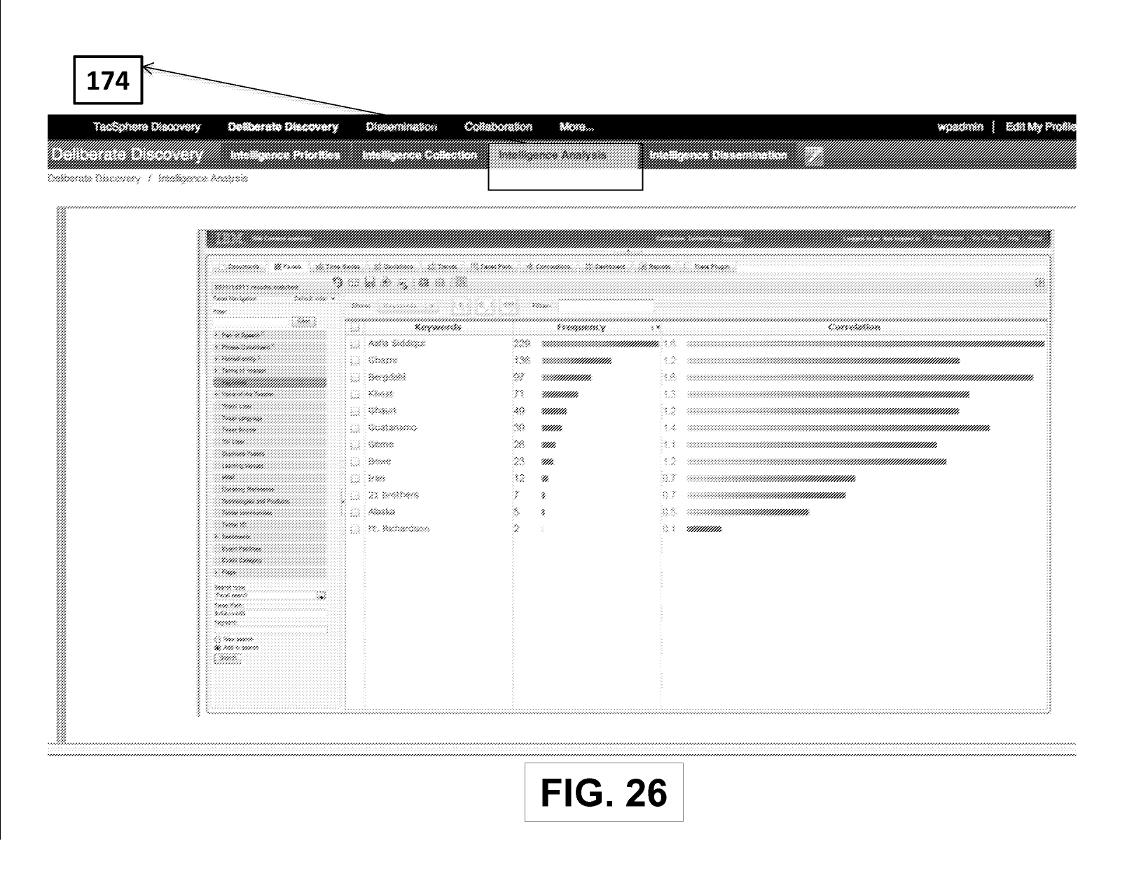

FIG. 26 illustrates another window within the user interface when a tab labeled “Deliberate Discovery” is selected and when an Intelligence Analysis tab 174 is selected. This window may display various analytic views of selected analytic engine interfaces for visualizing content.

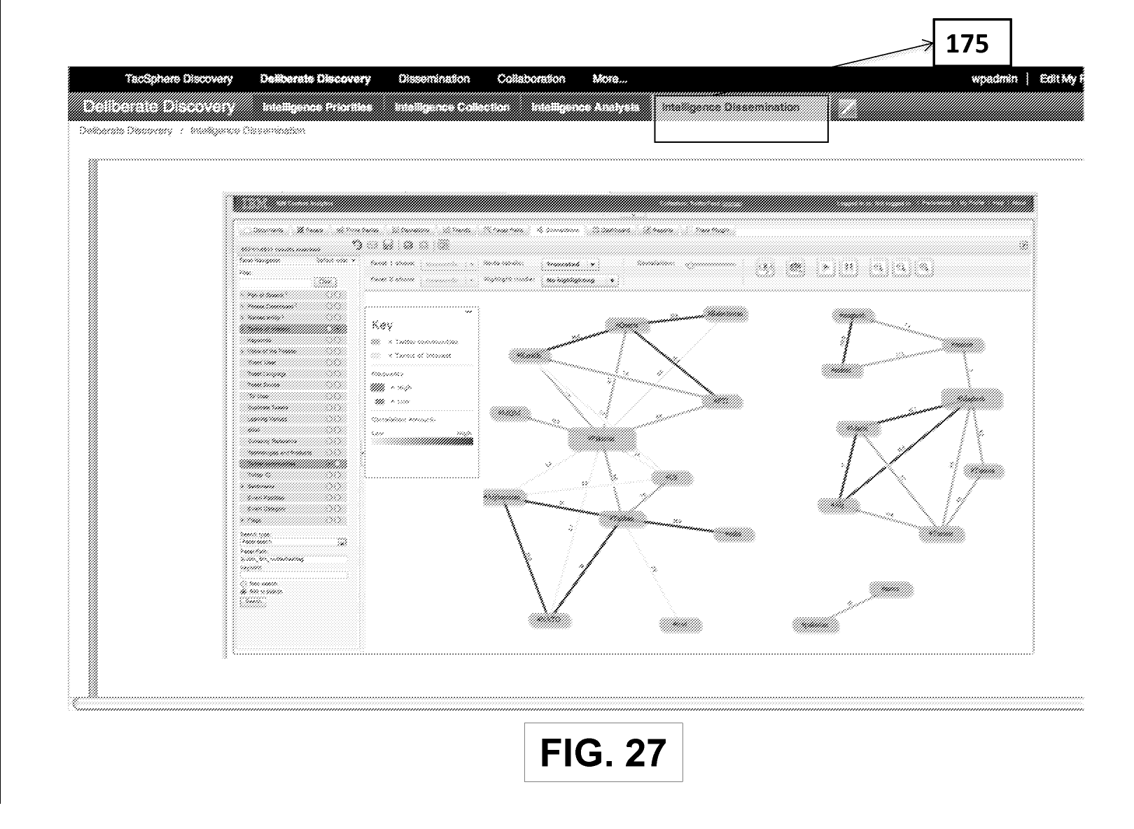

FIG. 27 illustrates another window within the user interface when a tab labeled “Deliberate Discovery” is selected and when an Intelligence Dissemination tab 175 is selected. This window enables a user to select a desired analytic view and package the view for dissemination to an organization.

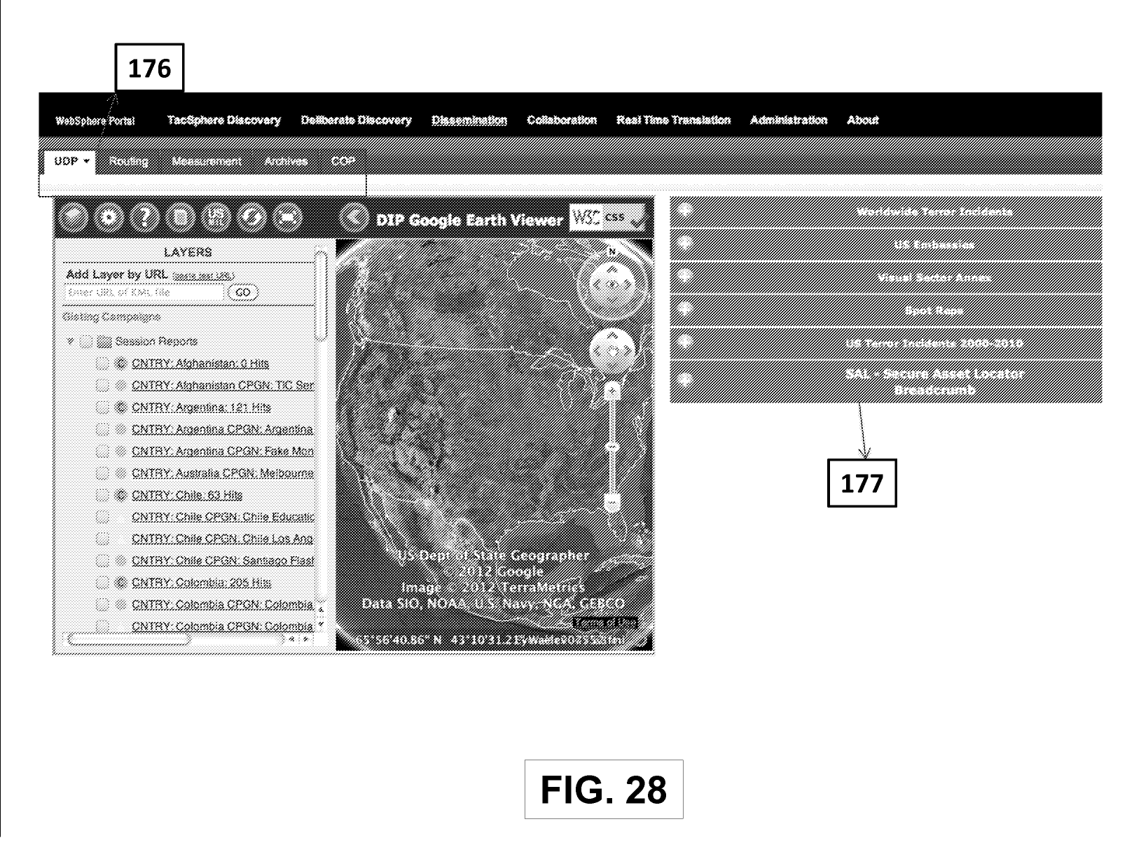

FIG. 28 displays a Dissemination window that may be displayed when the Dissemination tab is selected. Within the Dissemination window, various tabs 176 may be selected to display different forms that allow the user a combine of results for the sessions in a geospatial representation. For example, when a UDP (User Defined Picture) tab is selected, a user may define how data is presented in the field (e.g., to remote users). The UDP display includes expandable forms 177, each form enabling a user to access a respective repository of data that are relevant to the user's organizations. Each form has a data set specific to that form, which may be indicated as a title on the form. The data from the forms can be plotted geospatially on an adjacent map in order to represent relationships and promote discovery (e.g., draw relationships between different data).

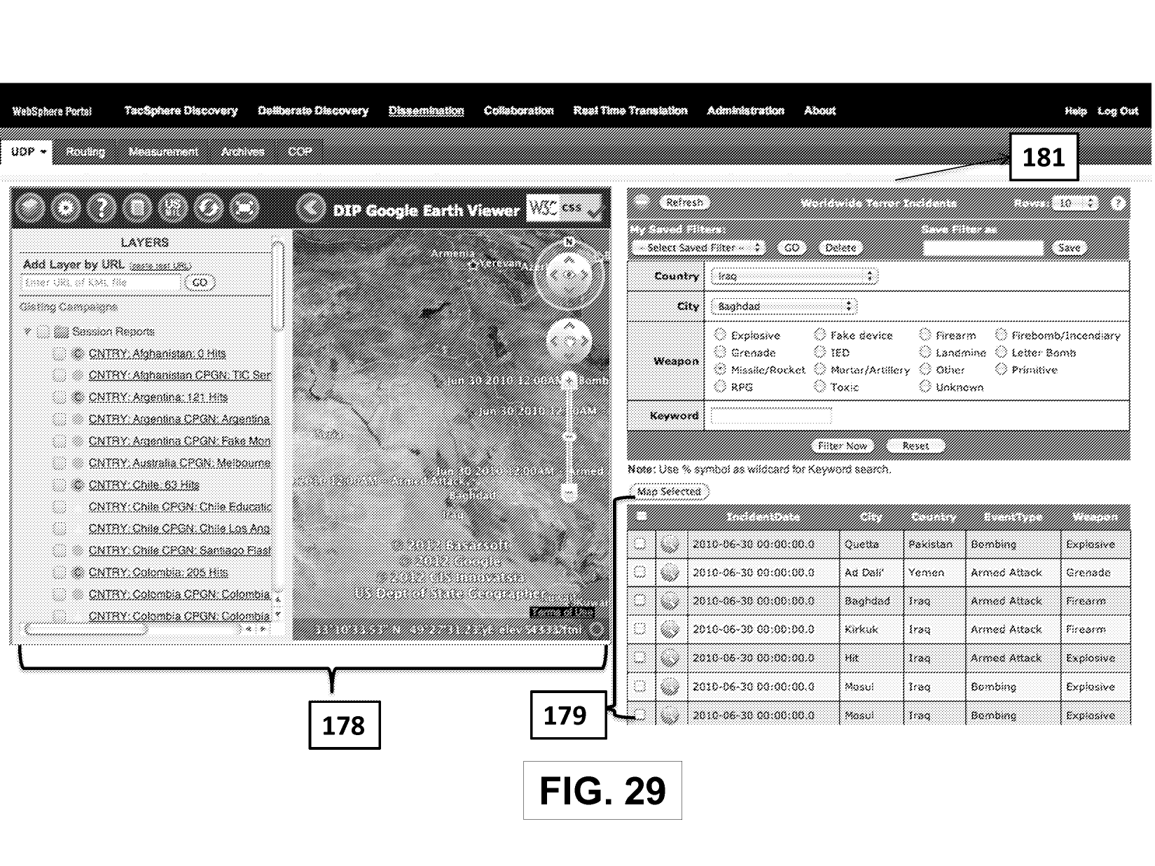

FIG. 29 illustrates various forms presented together in the Dissemination/UDP view according to various embodiments, when one of the forms 177 is expended. By way of illustration, FIG. 28 includes a form title Worldwide Terror Incidents. Form 178 includes a map that may geospatial plot historical data of terror incidents, and form 179 includes a list view of all the historical data related to worldwide terror incidents. Entries in the list can be selected and expanded. Form 179 may include a button (e.g., Map Selected button) that when selected, plots selected entries in the list onto the map in form 178. A Form 181, titled Worldwide Terror Incidents may include various fields having filter criteria that may be selected/entered for narrowing the data field the user sees based on, e.g., county, city or event, etc.

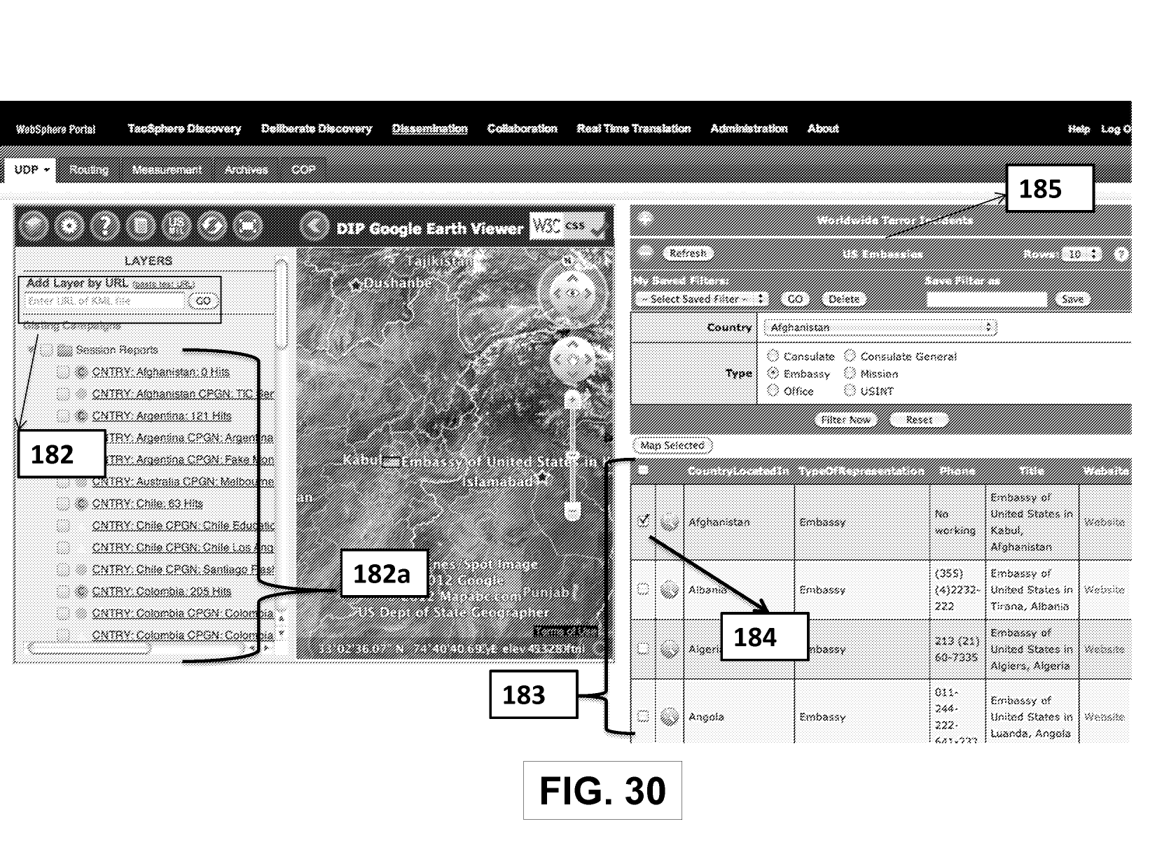

FIG. 30 illustrates the Dissemination/UDP view of FIG. 28 with a form 185 titled US Embassies expanded. As illustrated in this example, the map form may include a list of layers. Layers may be added to the list by specifying in form field 182 a URL or data captured (e.g., from a different site). Within the list are session reports 182a presented as selectable link that when selected plot the report data onto the map. When form 185 is expanded a list view form 183 of one or more embassies is displayed. Form 183 may include selectable and expandable rows, with each row including an embassy and an expansion of a row including a historical view of reported incidents. The form 183 may include a button (e.g., a Map Selected button). When a row 184 is selected by selecting an icon or (e.g., checking a box), subsequent selection of the button may plot the historical reports related to the selected row on the map.

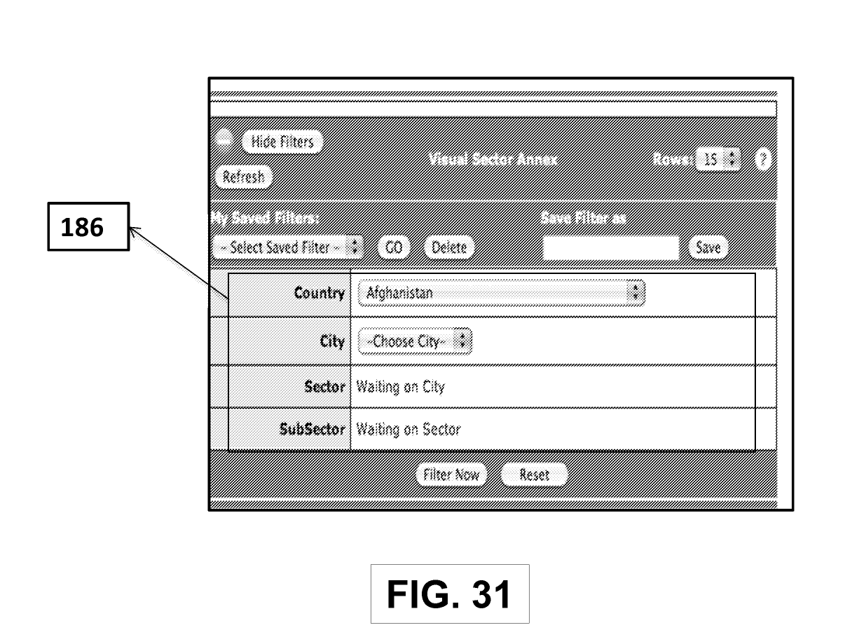

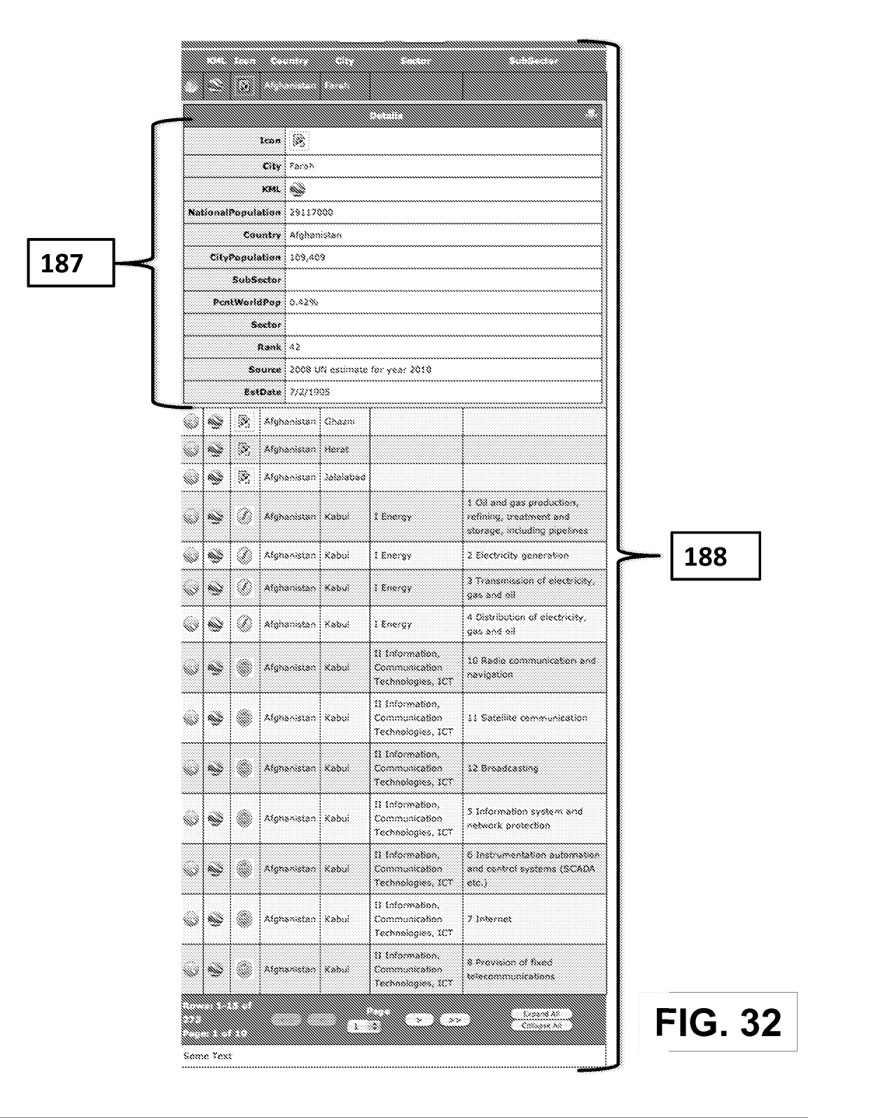

FIGS. 31-32 illustrate the Dissemination/UDP view of FIG. 28 with a form titled Visual Sector Annex expanded. Within this form fields 186 may be used to narrow a search for sectors by geospatial criteria (e.g., country, city, sector, etc.). Form 188 provides a list view of infrastructure sectors (e.g., Energy, Information, Communication Technologies, etc.) and sub sectors (e.g., electricity generation, radio communication and navigation, oil and gas production, etc.) associated with the search criteria in 186. Within list 188, a row 187 may be expanded to provide a detailed view of the specific row, which may be highlighted. The view gives the user the detail of that specific infrastructure sector.

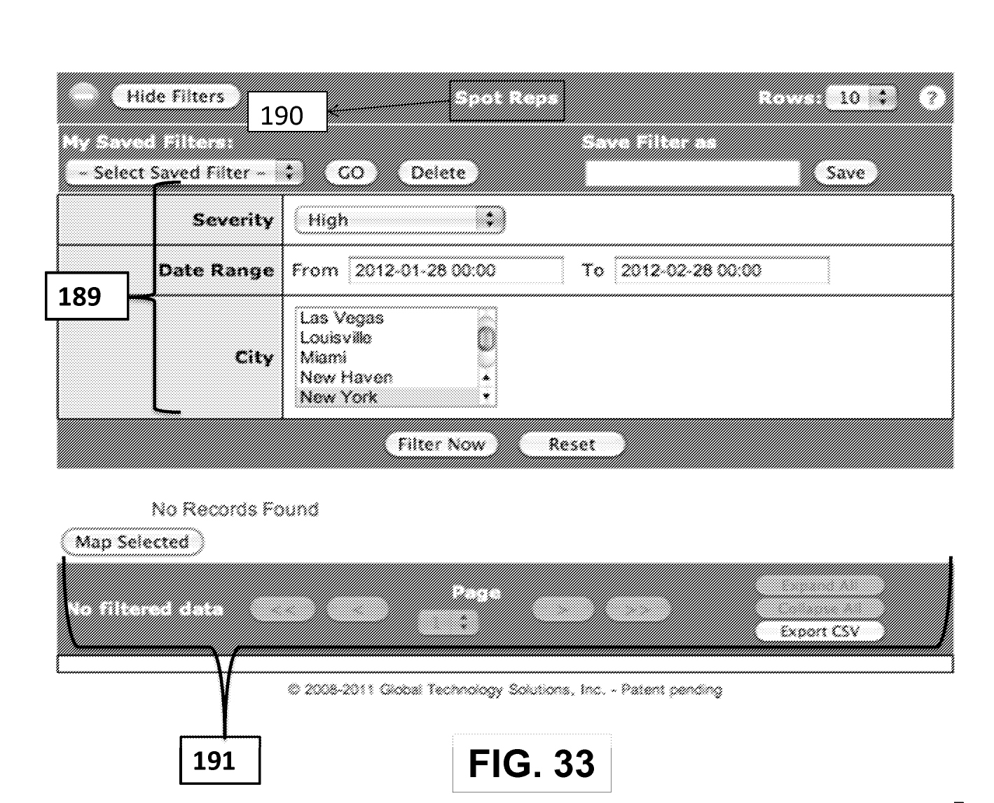

FIG. 33 illustrates the Dissemination/UDP view of FIG. 28 with a form titled Spot Reps expanded. This expanded form provides a list of repositories of reports made by users of the organization/case. The list may be tailored based on a user's credentials. The form includes a title 190 and a set of fields and pull down menus, which enables the user to establish a hasty spot report (e.g., a brief report). The fields may specify the severity of the report, a range of dates of the events being reported, and a geospatial area (e.g., a city). The fields 189 may include a button (e.g., a Filter Now button), that causes a list 191 of reports in the repositories that match the data entered into fields 189. The list 191 may include a button (e.g., a Map Selected) button that identifies selected reports from the list on the adjacent map (not shown) in this view.

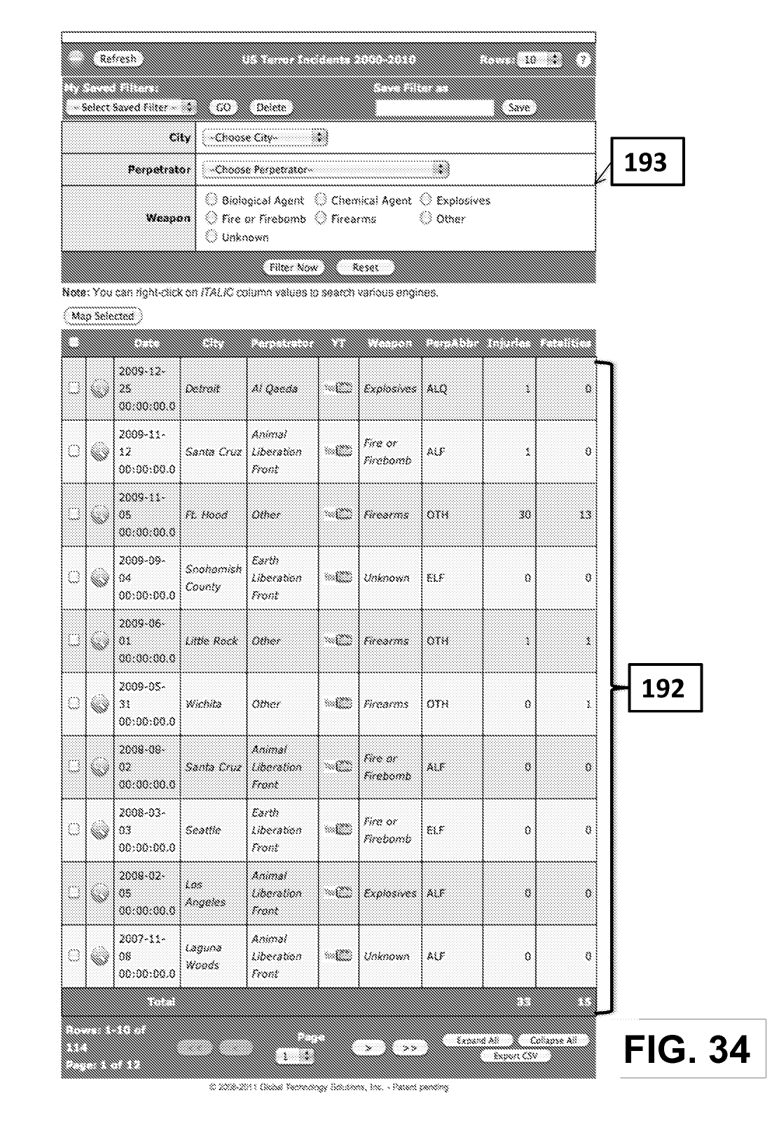

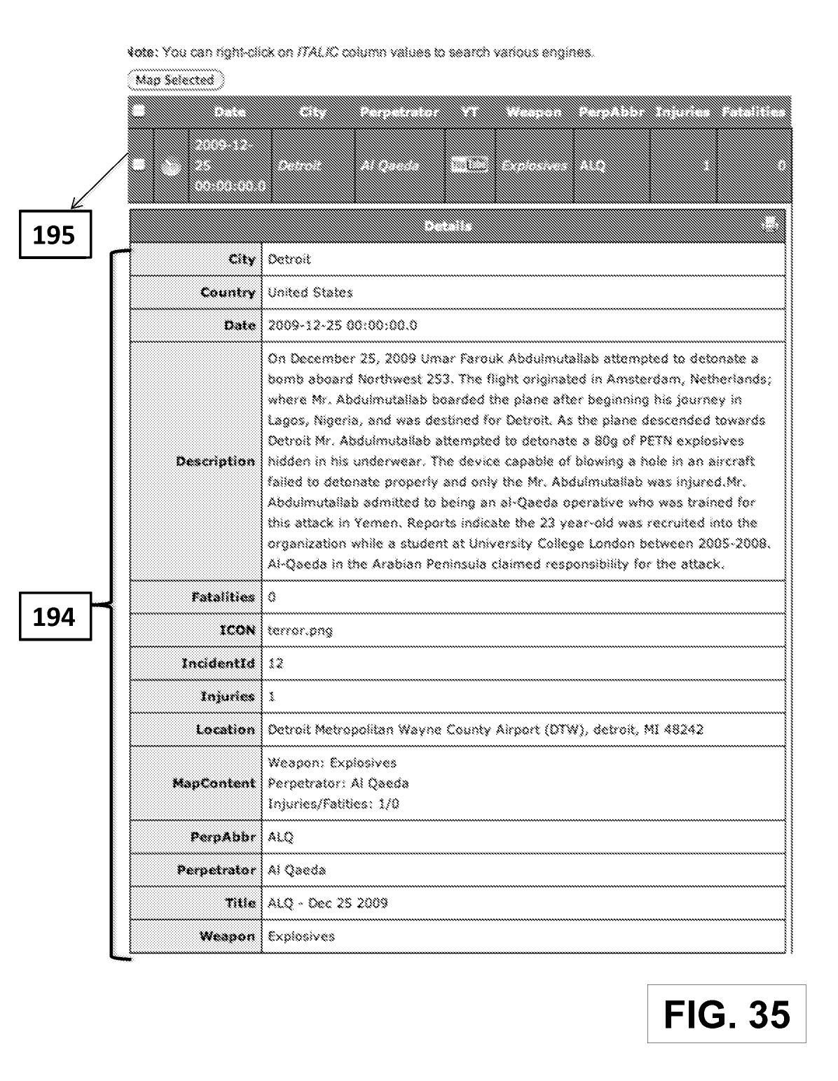

FIGS. 34 and 35 illustrate the Dissemination/UDP view of FIG. 28 with a form titled US Terror Incidents expanded. Form 192 includes a list view of all the historical data related to US terror incidents. Entries in the list can be selected and expanded. Form 192 may include a button (e.g., Map Selected button) that when selected, plots selected entries in the list onto the map in form 178. A Form 193 may include various fields having filter criteria that may be selected/entered for narrowing the list of entries the user sees based on, e.g., city, county, perpetrator, weapon, etc. Within form 192, a row 194 may be expanded to provide a detailed view of the specific row that included, e.g., location, date description, fatalities, injuries, an incident ID, mapping data, perpetrator, title, weapon, etc. Form 192 may also include a heading that enables a user to specify the arrangement of data in the rows within form 192.

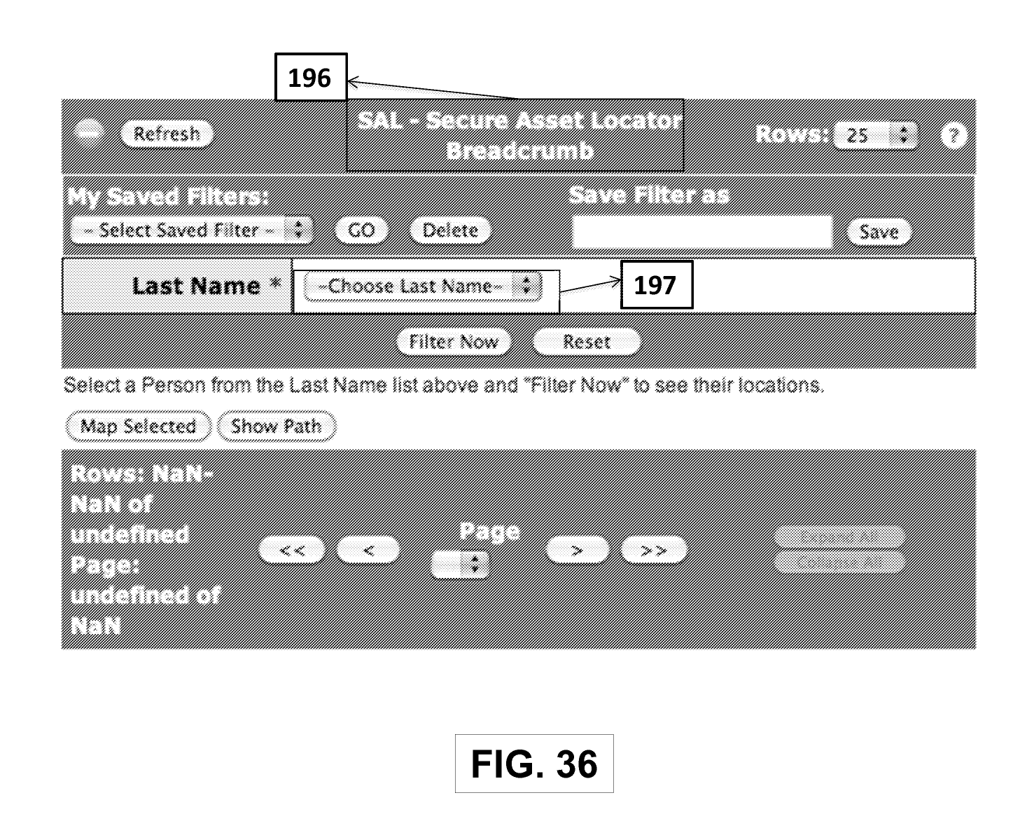

FIG. 36 illustrates the Dissemination/UDP view of FIG. 28 with a form titled “Secure Asset Locator Breadcrumb” expanded. The form may include a title 196, and may enable a user to track the locations of organizational assets (e.g., people), select those assets, and represent the assets on a map form 178. The form may have various Tillable or selectable fields, such as drop down men 197 that specify search criteria for an asset. The form may include a button (e.g., a Filter Now button) that will cause the form to list assets matching the search criteria. The Form may have another button (e.g., a Map Selected) button, that when selected, plots selected assets from the list on the map.

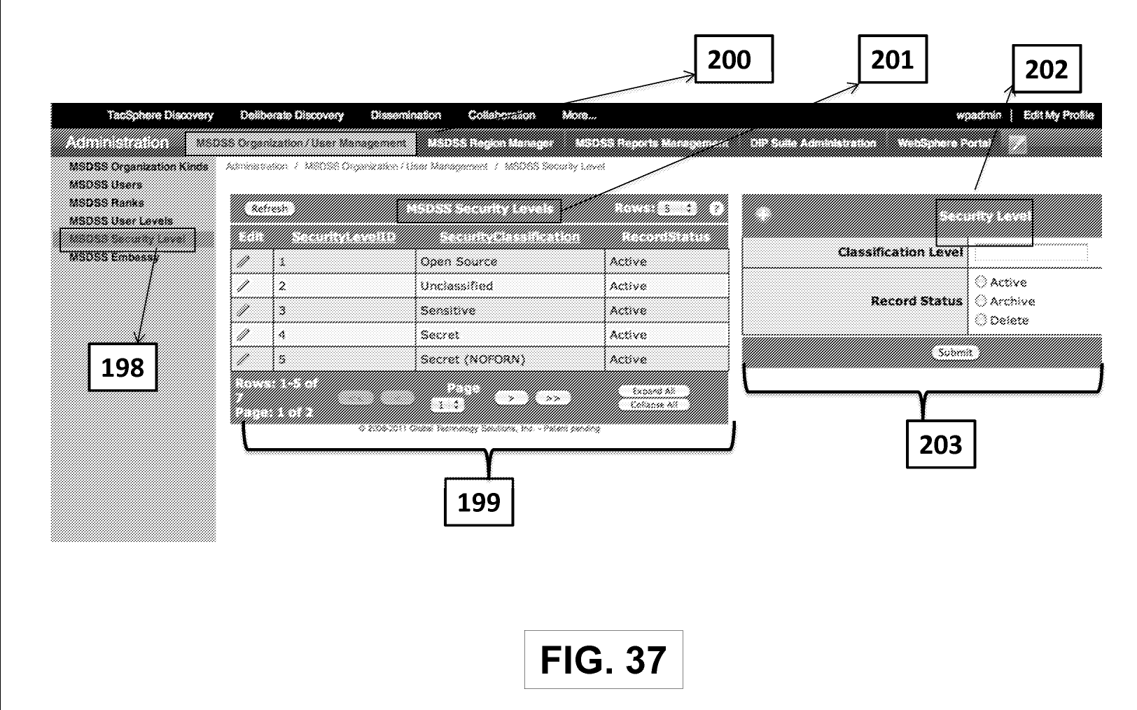

FIG. 37 illustrates an Administration window that may be displayed when the Administration tab is selected. Within the Administration window, various tabs may be selected to display different views that allow the user manage administrative issues of the organization and case. The Administration window may include a Security Level button 198, that when selected, enables a user (e.g., an administrator) to define the security levels of the organizations users.

Form 199 identified by title 201 may include a list of security levels used by administrator to define the classification levels of its users. The use may select the predetermined levels, which may auto populate an adjacent form 203 identified by label 202. 200: Administrative tab, which allows special permission to qualify the user levels. Form 203 may be used to specify additional security levels. Form 203 may include a button (e.g., a Submit button), that when selected, generates a new security level based on the content of the fields in form 203.

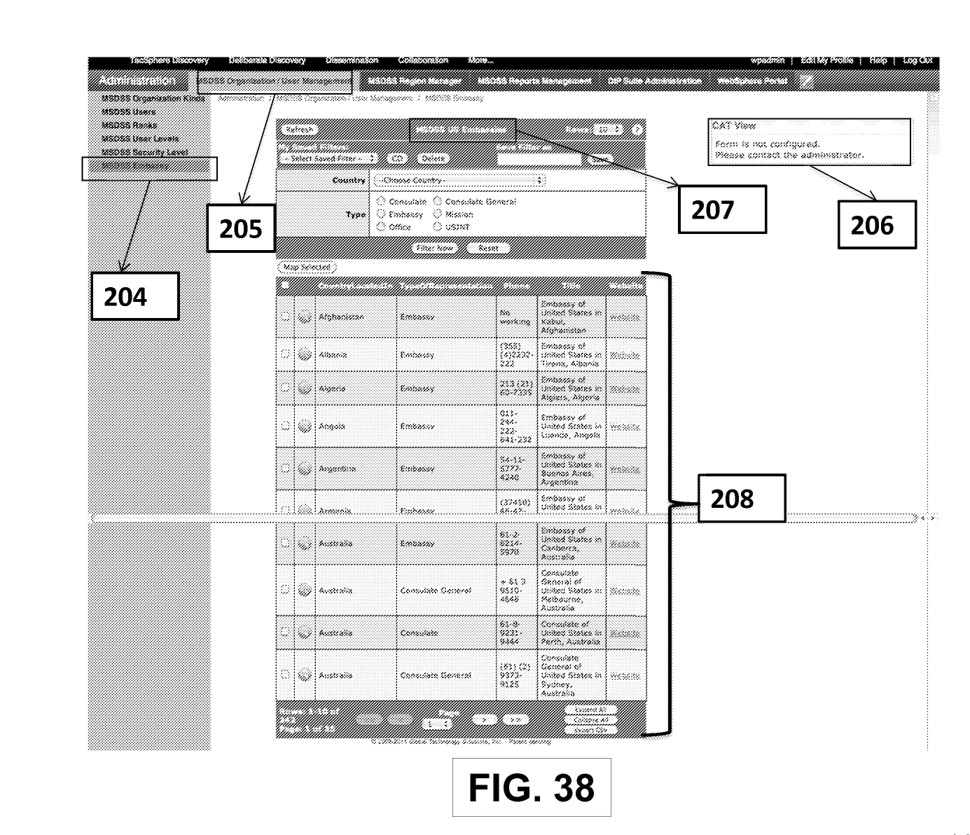

FIG. 38 illustrates the view in the Administration window that is displayed when an Embassy button 204, that when selected, enables a user (e.g., an administrator) edit and manage US embassy data, details, contact information, and comments. The Administration window may include a tab 205 to navigate to the administration function view related to the user and organization. Form 206 is configurable and reserved for an administrator (or other user) to create a specific form, map, or portlet (organization defined). A form titled US Embassies 207 may include selectable search criteria for specifying which US embassies, consulates and other interests to list in form 208. Each row in 208 identifies a different interest meeting the criteria. Each row may be expandable to review further details of the listed interest.

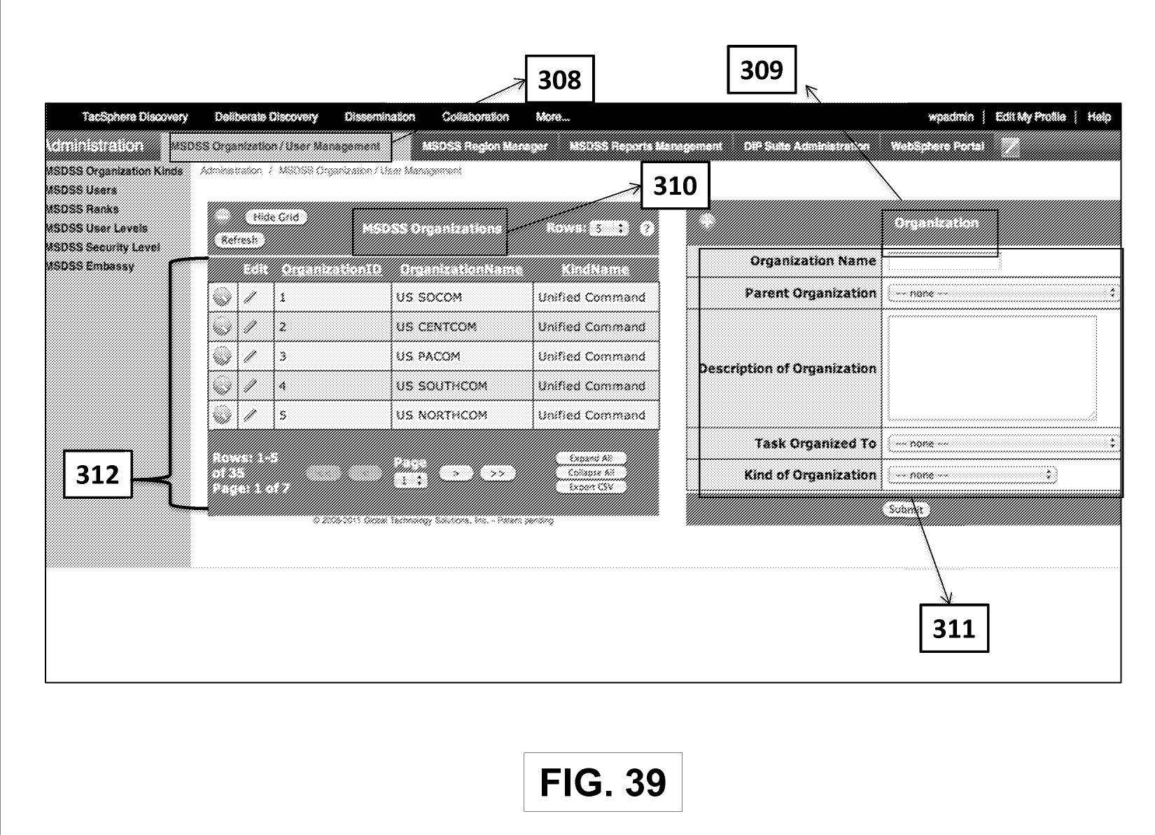

FIG. 39 illustrates the view in the Administration window that is displayed when User Management navigation tab 308 is selected. When in this view, an administrator may manage organizational users. A title 310 identifies a form as a list 312 of MSDSS organizations. Each entry on the list is expandable to disclose more details about the expanded organization. Another form identified by title 309 as an organization, includes Tillable fields and drop down menus to edit or create new organizational reporting and matrix structures.

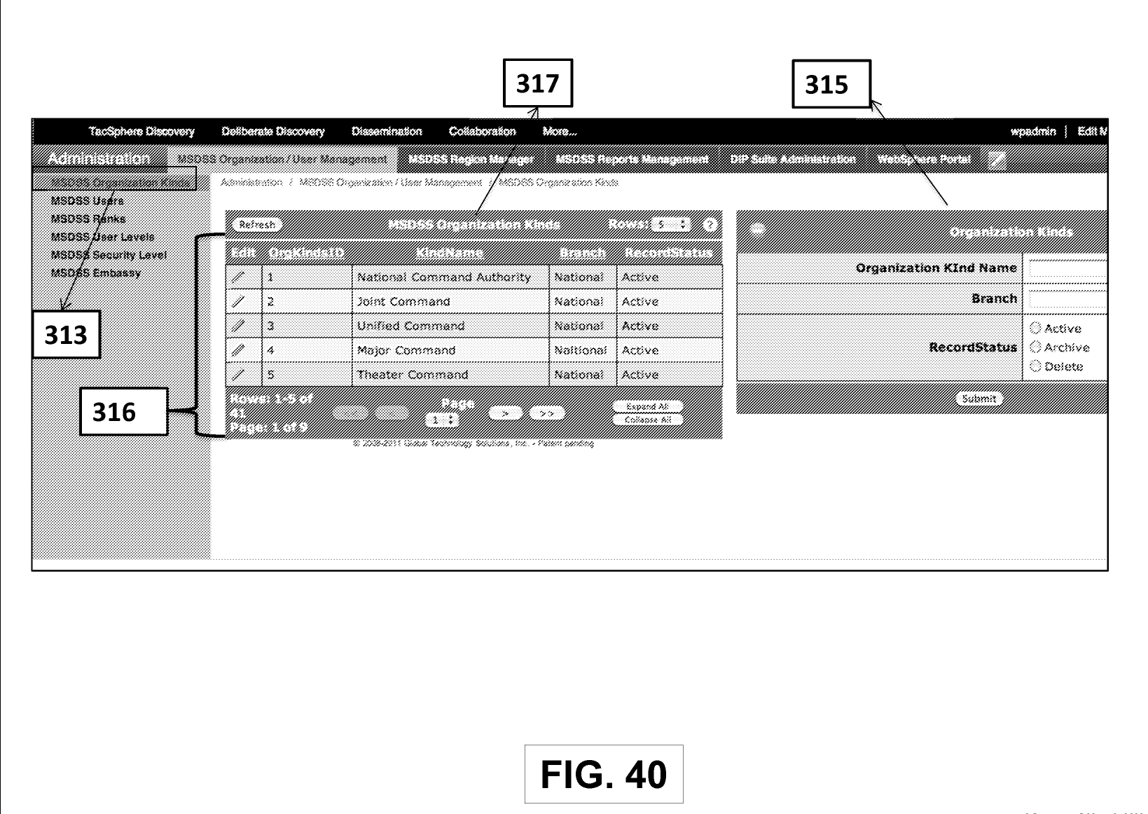

FIG. 40 illustrates the view in the Administration window that is displayed when a User Management navigation tab 308 is selected and an organization Kinds button 313 is selected. This view enables a user (e.g., an administrator) to manage organizational kinds (e.g., National Command Authority, Joint Command, Unified Command, Major Command, Theater Command, etc.). This view may include a form 317, titled organization Kinds, that includes a list 316 of organizational kinds identified by, for example, an identification number, kind name, branch of the organization, and status of the record (e.g., active/inactive). The view may also include a form 315 for creating and/or editing organizational Kinds. Form 315 may include fields and selectable options for specifying the information in form 317. The fields and options in form 315 may be auto-populated by selecting one of the organizational kinds listed in list 316. Auto-population copies the information in the selected row and pastes the information in the fields and selectable options in the form to be filled out.

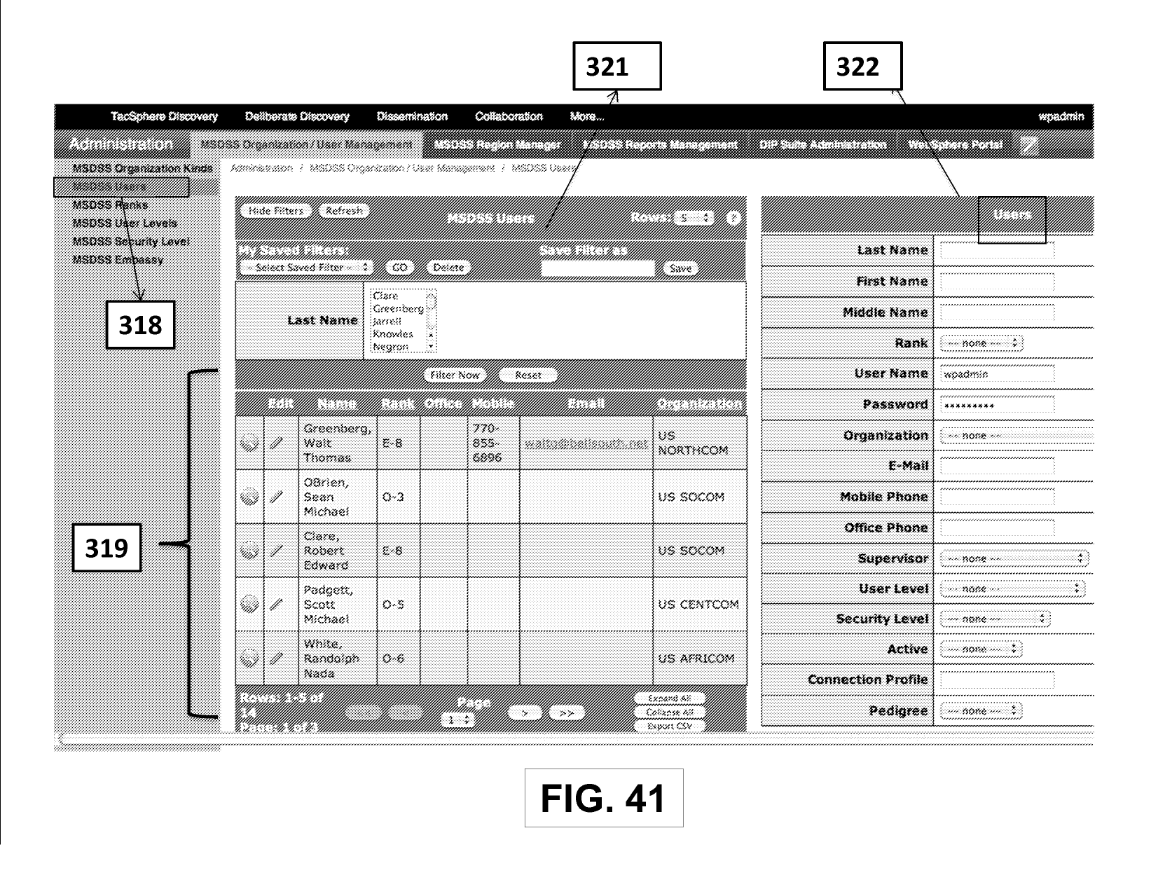

FIG. 41 illustrates the view in the Administration window that is displayed when a User Management navigation tab 308 is selected and a Users button 318 is selected. This view enables a user (e.g., an administrator) to manage user/operators of the MSDSS system. This view may include a form 321, titled Users, that includes a list 319 of users that have access (e.g., have an account, login, etc.) to the MSDSS system. Each row of list may identify a user's name, position in the organization (e.g., rank), location (e.g., office), contact information (e.g., phone numbers, email, etc.), and organization to which the user is affiliated. Form 321 may include a search fields for which to filter users listed in list 319. The search fields may include, for example, a search field, a scrollable list of user identified by name, etc. The view may also include a form 322 for creating and/or editing user accounts. Form 322 may include fields and selectable options for specifying the information in form 319 for a particular user. The fields and options in form 322 may be auto-populated by selecting one of the organizational kinds listed in list 321.

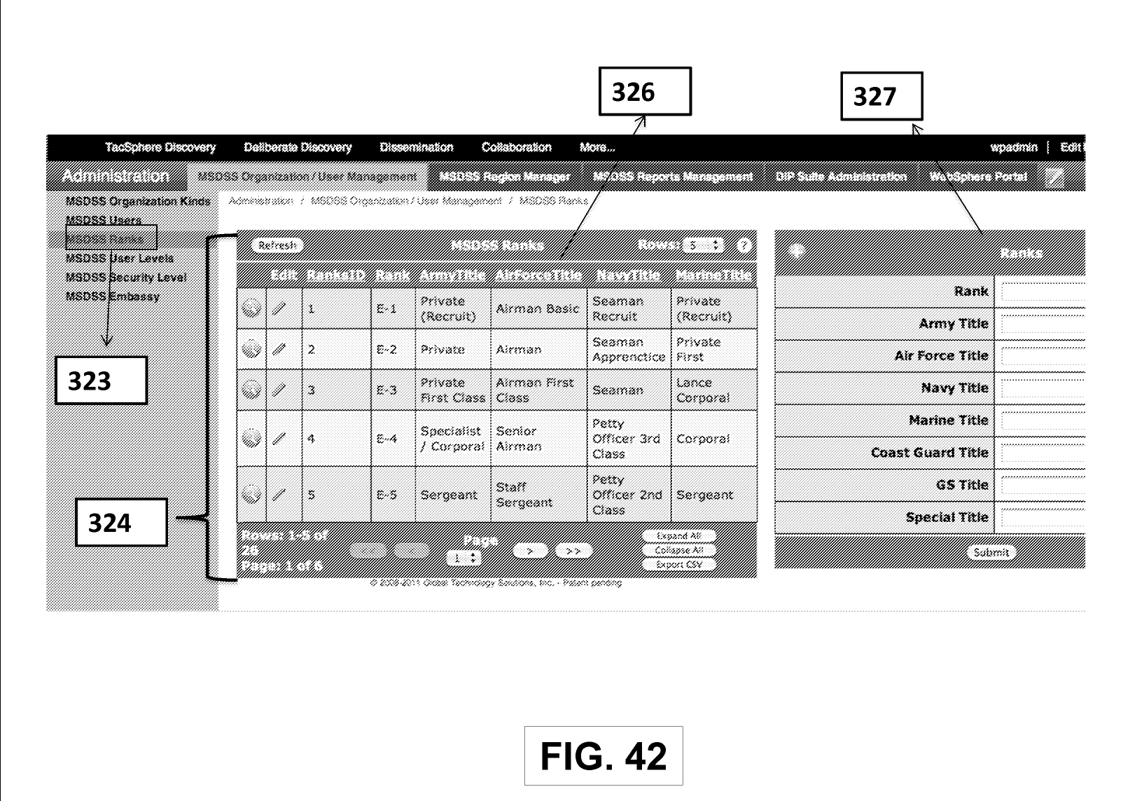

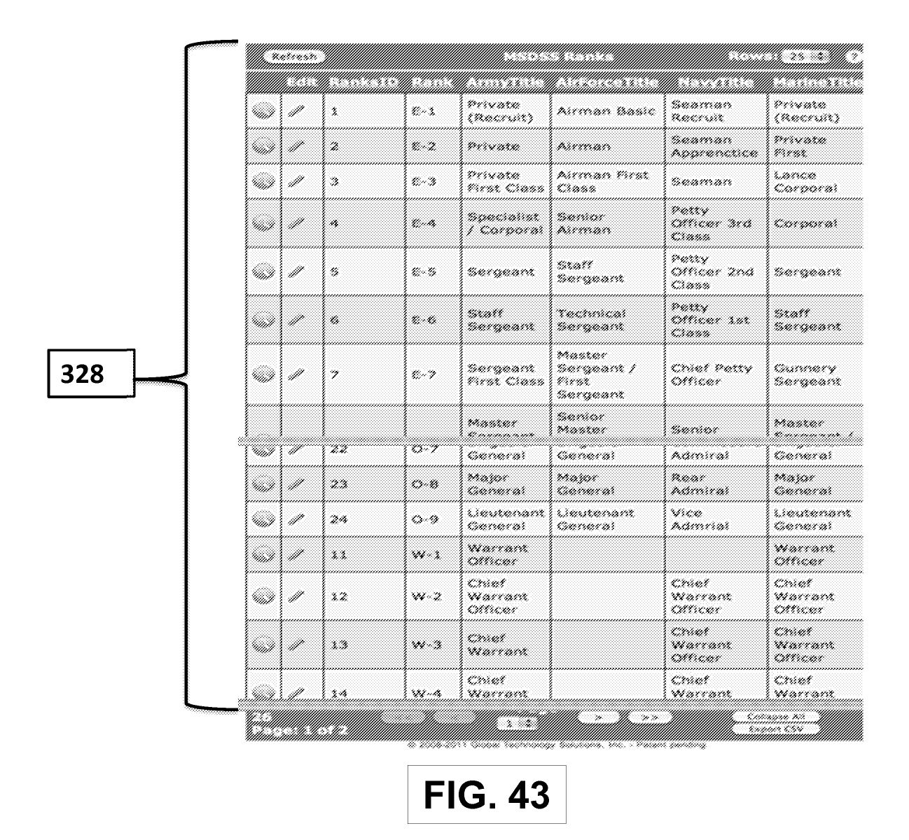

FIG. 42 illustrates the view in the Administration window that is displayed when a User Management navigation tab 308 is selected and a Ranks button 323 is selected. This view enables a user (e.g., an administrator) to manage positions (e.g., ranks) and pay grade structures pertinent to organizations (e.g., specific Department of Defense organization). This view may include a form 326, titled Ranks, that includes a list 324 of user positions. Each row of list may identify a position by an identification number, rank, pay grade, and titles in different organizations or different branches of an organization (e.g., army, air force, and navy, marine). Entries in list 324 may be edited. This view may also include a form 327 for creating and/or editing the positions (e.g., ranks) Form 327 may include fields and selectable options for specifying the information in form 324 for a particular position. The fields and options in form 324 may be auto-populated by selecting one of the positions listed in list 324. FIG. 43 illustrates an alternate view 328 of list 324 that displays multiple pages of the list.

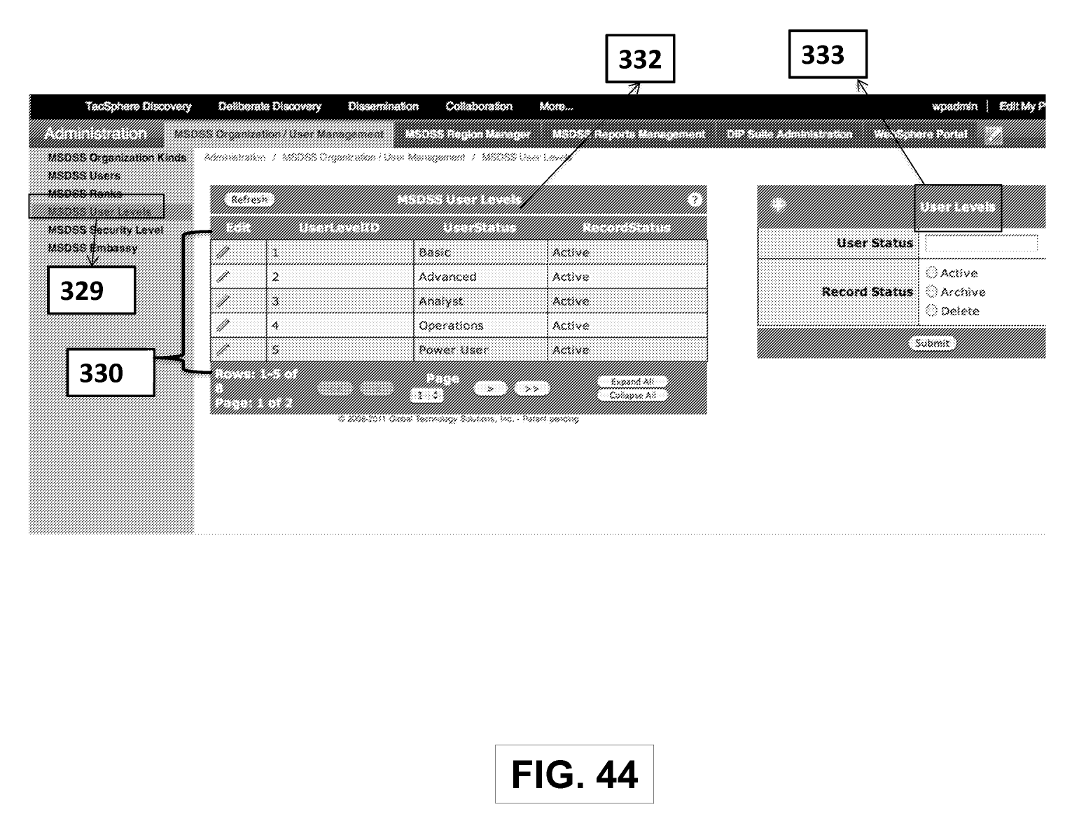

FIG. 44 illustrates the view in the Administration window that is displayed when a User Management navigation tab 308 is selected and a Users Level button 329 is selected. This view enables a user (e.g., an administrator) to manage User levels that may be assigned to each user account to provide different levels of capabilities and permissions permitted for each user account. This view may include a form 332, titled User Levels, that includes a list 330 of user levels. Each row of the list may identify a level identification, user status associated with the level, and a record status indicating whether the particular level is active or archived. The view may also include a form 333 for creating and/or editing user levels. Form 333 may include fields and selectable options for specifying the information in form 332 for a particular user level. The fields and options in form 333 may be auto-populated by selecting one of the user levels listed in list 330.

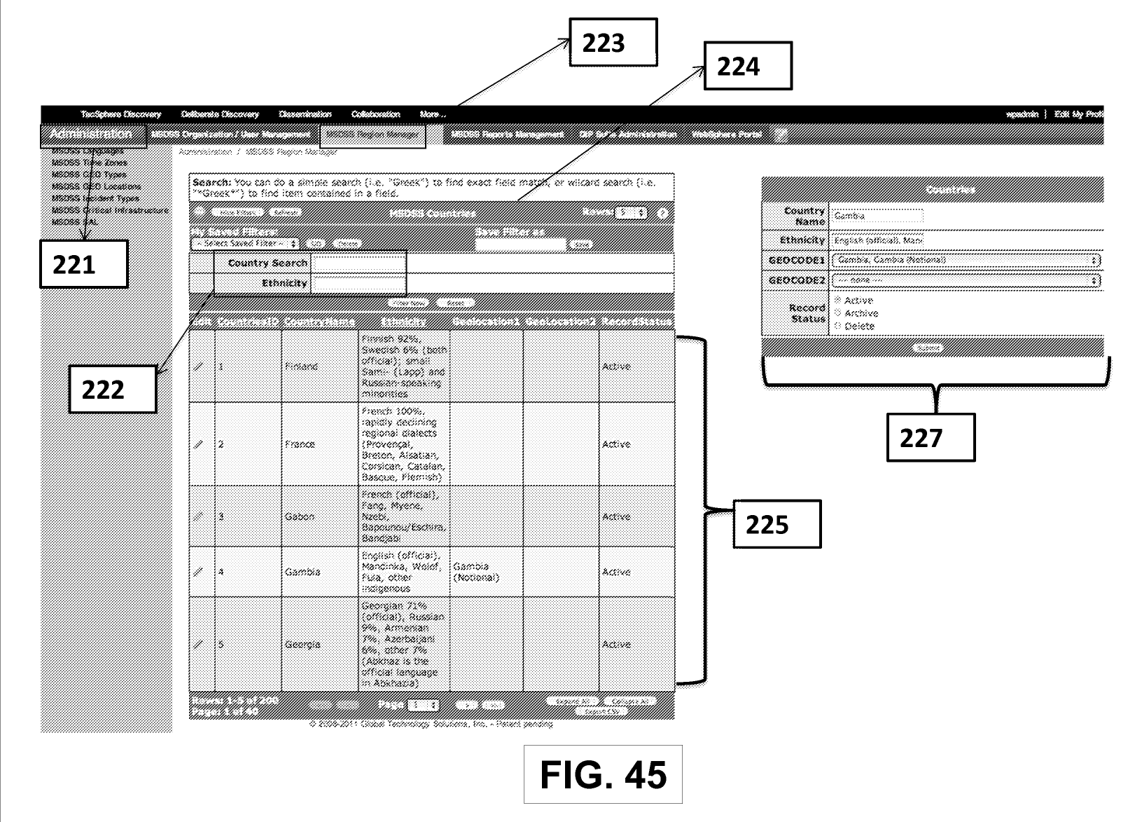

FIG. 45 illustrates the view in the Administration window (indicated by 221) that is displayed when a Regional Manager navigation tab 223 is selected. This view enables a user (e.g., an administrator) to manage/define geospatial regions (e.g., countries) and assign properties (e.g., name, ethnicity, geospatial locations, etc.) This view may include a form 224, titled Countries, that includes a list 225 of regions (e.g., countries). Each row of the list may identify a different region identified by an identification number, and the properties assigned to the regions. Form 224 may include one or more fields 222 for filtering the regions displayed in the list 225. Each row in the list may be expanded to view details about the region. This view may also include a form 227 for creating and/or editing regions. Form 227 may include editable fields and selectable options for specifying the information in form 224 for a particular region. The fields and options in form 227 may be auto-populated by selecting one of the regions listed in list 225.

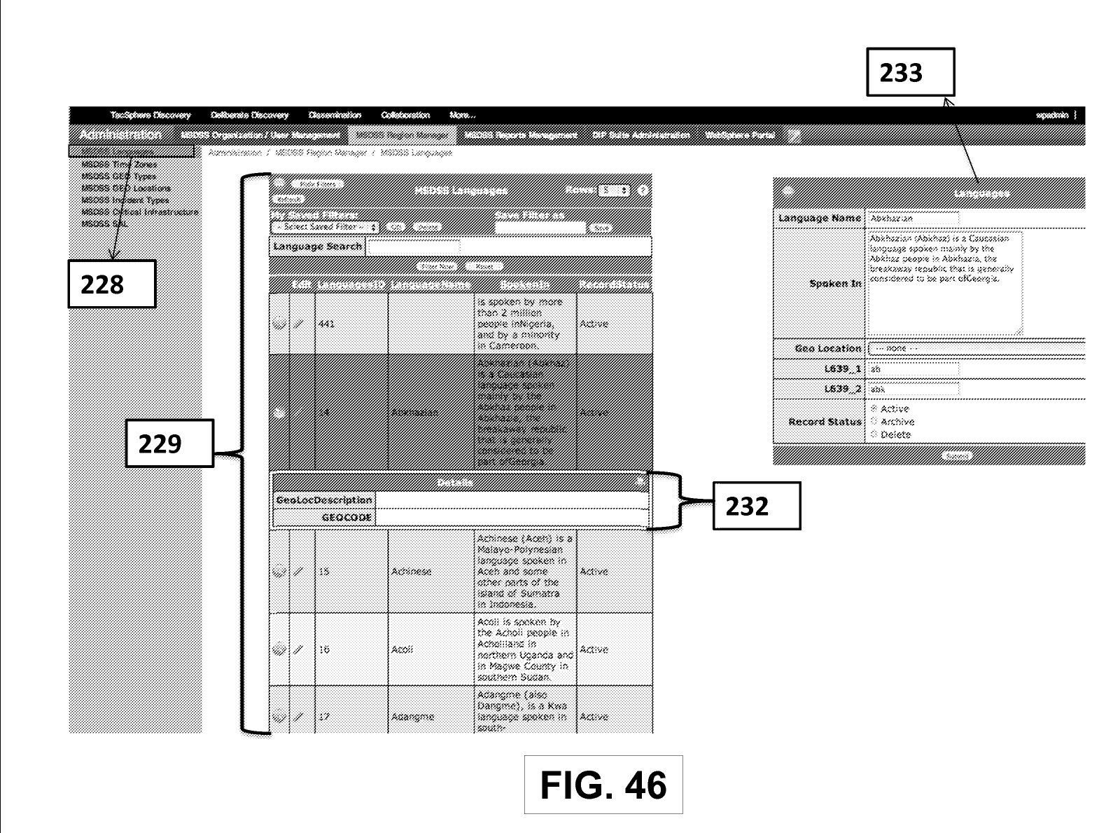

FIG. 46 illustrates the view in the Administration window that is displayed when a Regional Manager navigation tab 223 is selected, and when a Languages button 228 is selected. This view enables a user (e.g., an administrator) to define languages that can be associated with different geospatial locations. This view may include a form 229, titled Languages, which includes a list of all defined languages. Form 229 may include editable filter fields to filter the languages listed in the form. This view may also include a form 233 for creating and/or editing defined languages. Form 233 may include editable fields and selectable options for specifying the information in form 229 for a particular language. The fields and options in form 233 may be auto-populated by selecting one of the regions listed in list 229. Form 233 may include a button (e.g., a Submit button), that when selected creates a new language entry or updates the data of an existing language entry.

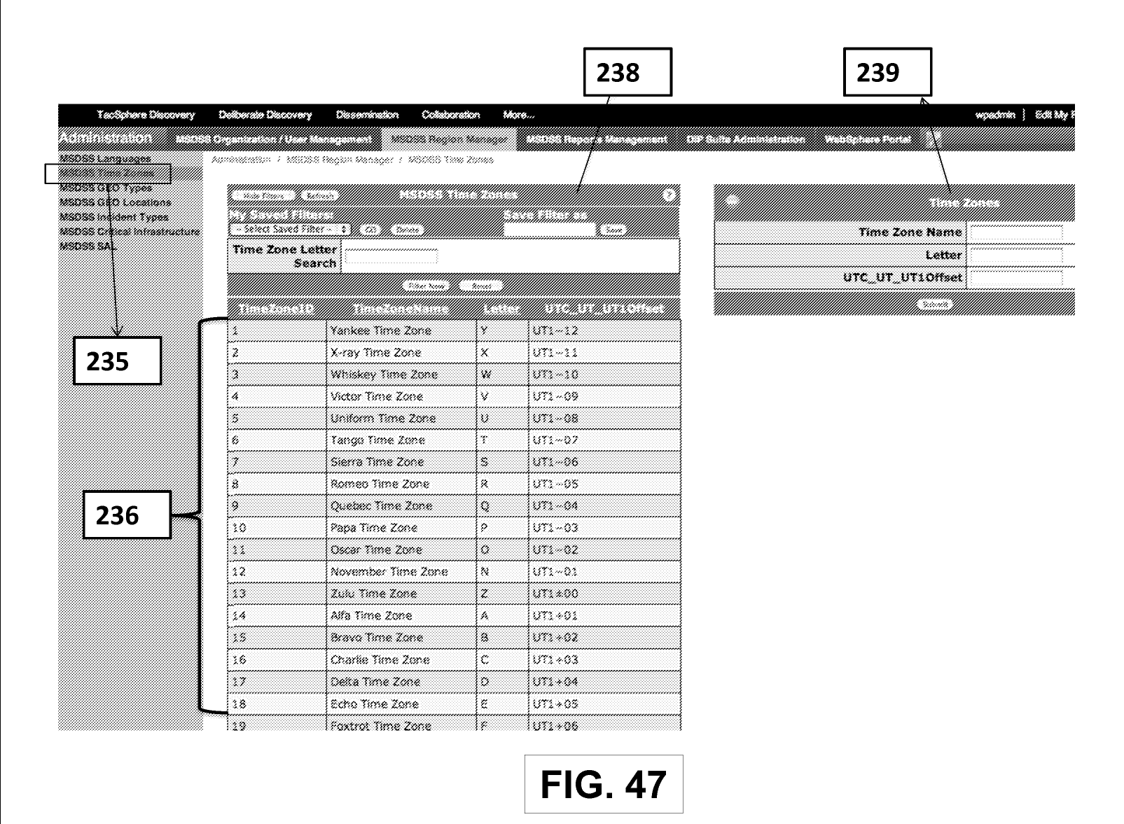

FIG. 47 illustrates the view in the Administration window that is displayed when a Regional Manager navigation tab 223 is selected, and when a Time Zones button 235 is selected. This view enables a user (e.g., an administrator) to define time zones for different geospatial that can be associated with different geospatial locations. This view may include a form 238, titled Time Zones, which includes a list 236 of defined time zones. Form 238 may include editable filter fields to filter the time zones listed in the list 236. Each row in the list may identify a time zone, by identification number, name, identification letter, and an offset to common time standard (e.g., UTC). This view may also include a form 239 for creating and/or editing defined time zones. Form 239 may include editable fields for specifying the information in form 238 for a particular time zone. The fields in form 239 may be auto-populated by selecting one of the time zones listed in list 236. Form 239 may include a button (e.g., a Submit button), that when selected creates a new time zone entry or updates the data of an existing time zone entry.

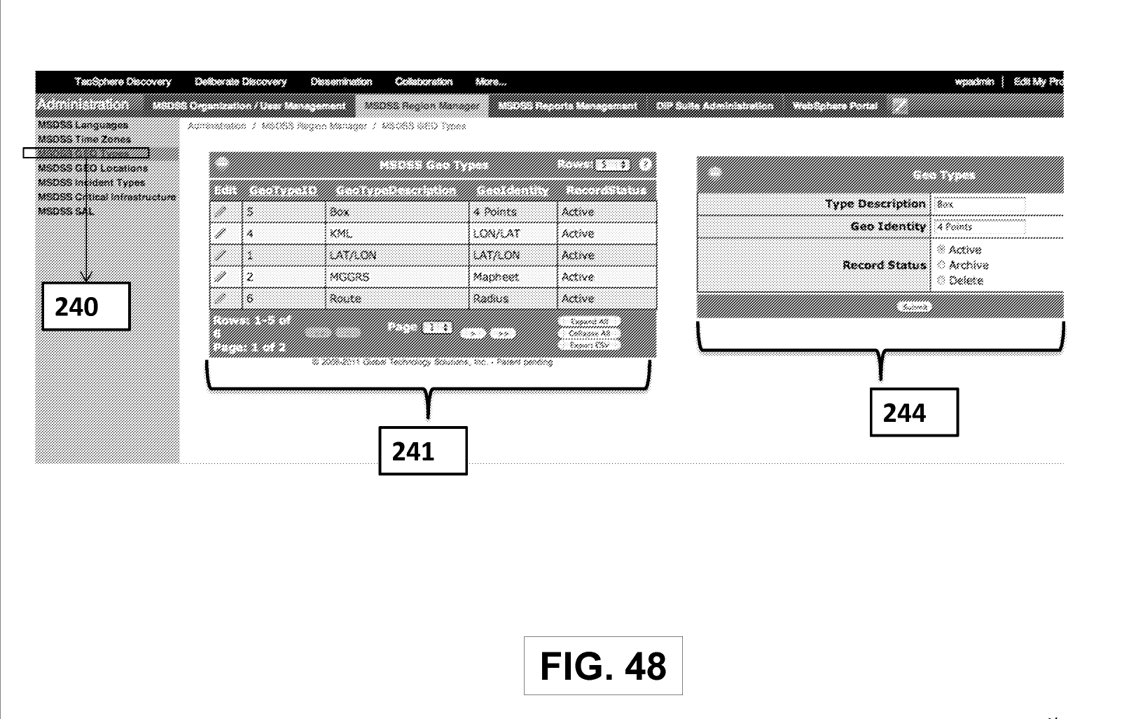

FIG. 48 illustrates the view in the Administration window that is displayed when a Regional Manager navigation tab 223 is selected, and when a Geo Types button 240 is selected. This view enables a user (e.g., an administrator) to define different geo-coordinate types for geo-codes (e.g., geospatial information such as boxes, latitude/longitude, KML, Route, etc.), which are displayable on MSDSS maps. This view may include a form 241, titled Geo Types, which includes a list of defined geo types. Each row in the list may identify a geo type, by identification number, description, display aspects, etc. This view may also include a form 244 for creating and/or editing defined geo types. Form 244 may include editable fields and selectable options for specifying the information in form 241 for a particular geo type. The fields in form 244 may be auto-populated by selecting one of the geo types listed in list 241. Form 244 may include a button (e.g., a Submit button), that when selected creates a new geo type or updates the data of an existing geo type.

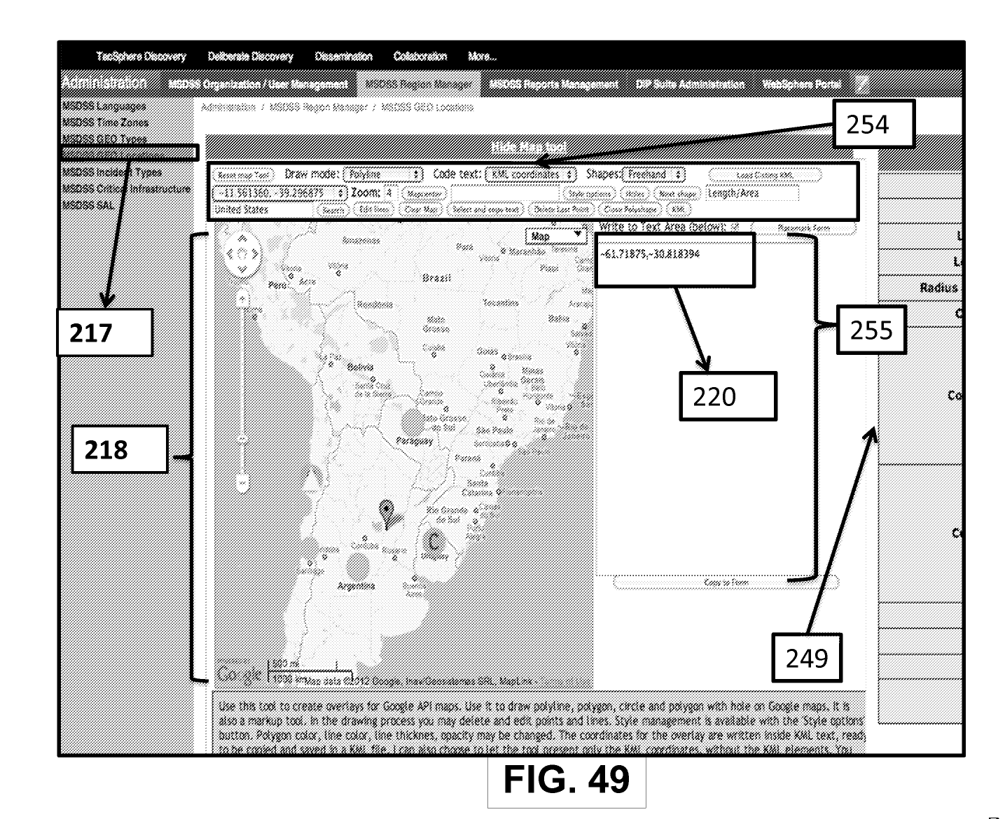

FIG. 49 illustrates the view in the Administration window that is displayed when a Regional Manager navigation tab 223 is selected, and when a GEO Locations button 217 is selected. This view enables a user (e.g., an administrator) to geospatially locate various attributes, such as gist concepts, session reports, and capture the associated geocode data for use in a reporting process. This view may include an interactive map tool form 218, on which relevant data, social data, geocodes are located and extracted. Within the form, a field 255 may display text and/or geocode data 220 of different geo types (e.g., latitude and longitude, etc.) of selections on the map. Data 220 may be dragged and dropped into adjacent form 249. A form 254 may include a map tool bar used to identify and capture data located on the map.

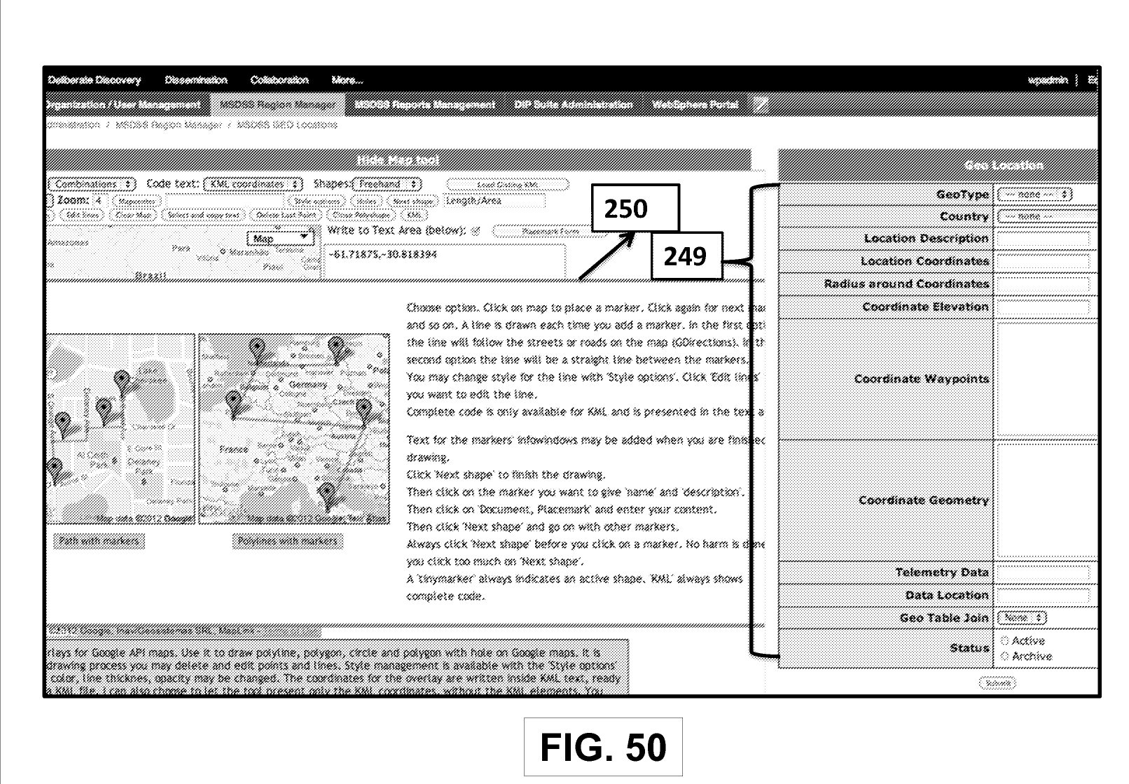

FIG. 50 illustrates additional forms that may be included in the Geo Locations view of FIG. 49. Form 250 includes instructions for placing markers and other geo codes on the map in form 218. This view may also include a form 249 for creating and/or editing geo codes stored in the MSDSS system. Form 249 may include editable fields and selectable options for specifying the information of a geo code displayed in map form 218. The fields in form 249 may be auto-populated by dragging and dropping geo codes from map 218 onto form 249. Data associated with the geo code will populate the fields of form 249. The fields may be edited by the user. Form 244 may include a button (e.g., a Submit button), that when selected updates the data associated with the geocode in a database of the MSDSS.

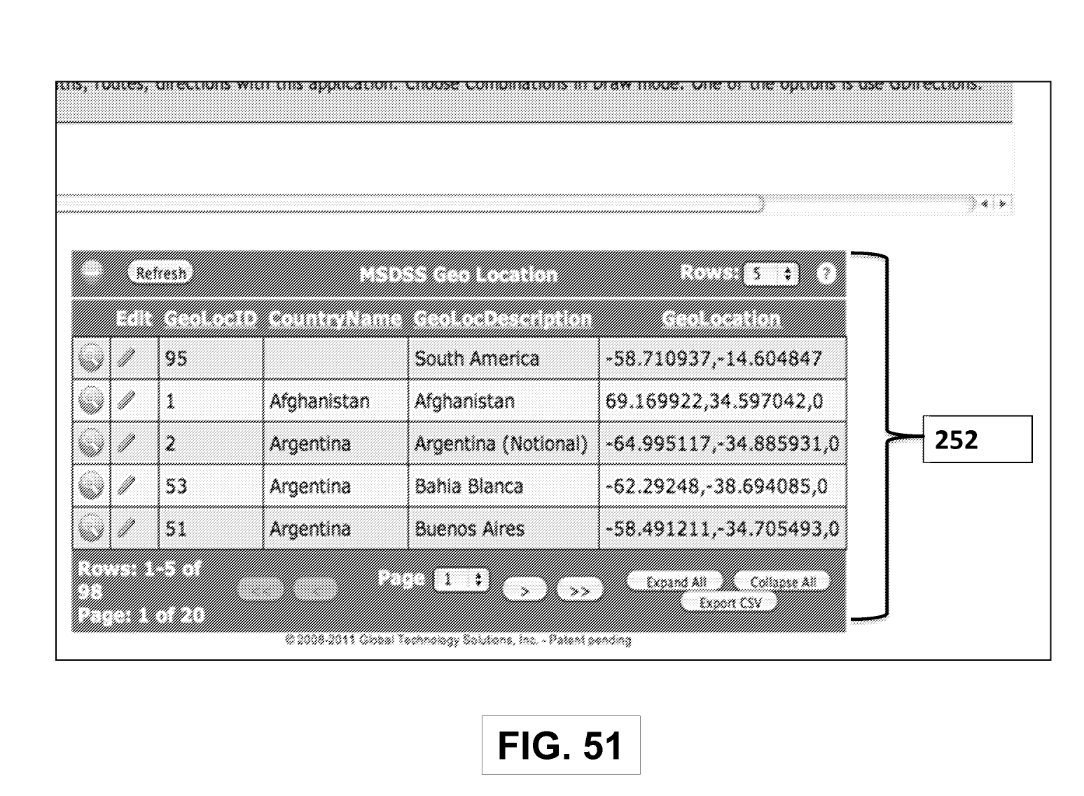

FIG. 51 illustrates an additional form 252 that may be included in the Geo Locations view of FIG. 49. Form 252 includes a list of country codes associated with each country. Each row identifies a country code by a location identification number, a name, a description, and by a location (e.g., latitude and longitude). Each row is expandable to view additional details about the country code.

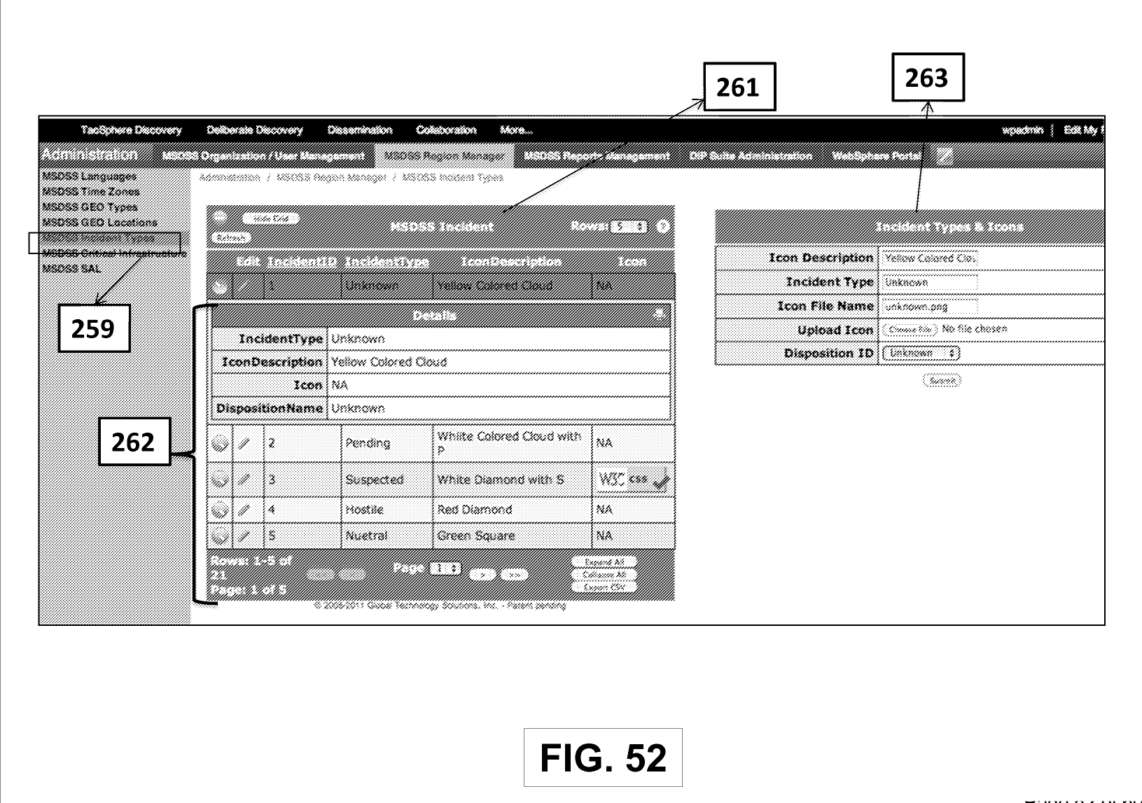

FIG. 52 illustrates the view in the Administration window that is displayed when a Regional Manager navigation tab 223 is selected, and when an Incident Types button 259 is selected. This view enables a user (e.g., an administrator) to define different incident types that may be identified in MSDSS interactive maps and in reports. This view may include a form 261, titled Incident, which includes a list 262 of defined incident types. Each row in the list may identify an incident type by identification number, incident type label (e g , unknown, pending, suspected, hostile, neutral, etc.), description, display aspects (e.g., icon description, icon), etc. Rows in list 262 may be expandable to reveal additional details about the selected incident type. This view may also include a form 263 for creating and/or editing incident types. Form 263 may include editable fields and selectable options for specifying the information in form 261 for a particular incident type. The fields in form 263 may be auto-populated by selecting one of the incident types listed in list 261. Form 263 may include a button (e.g., a Submit button), that when selected creates a new incident type or updates the data of an existing incident type.

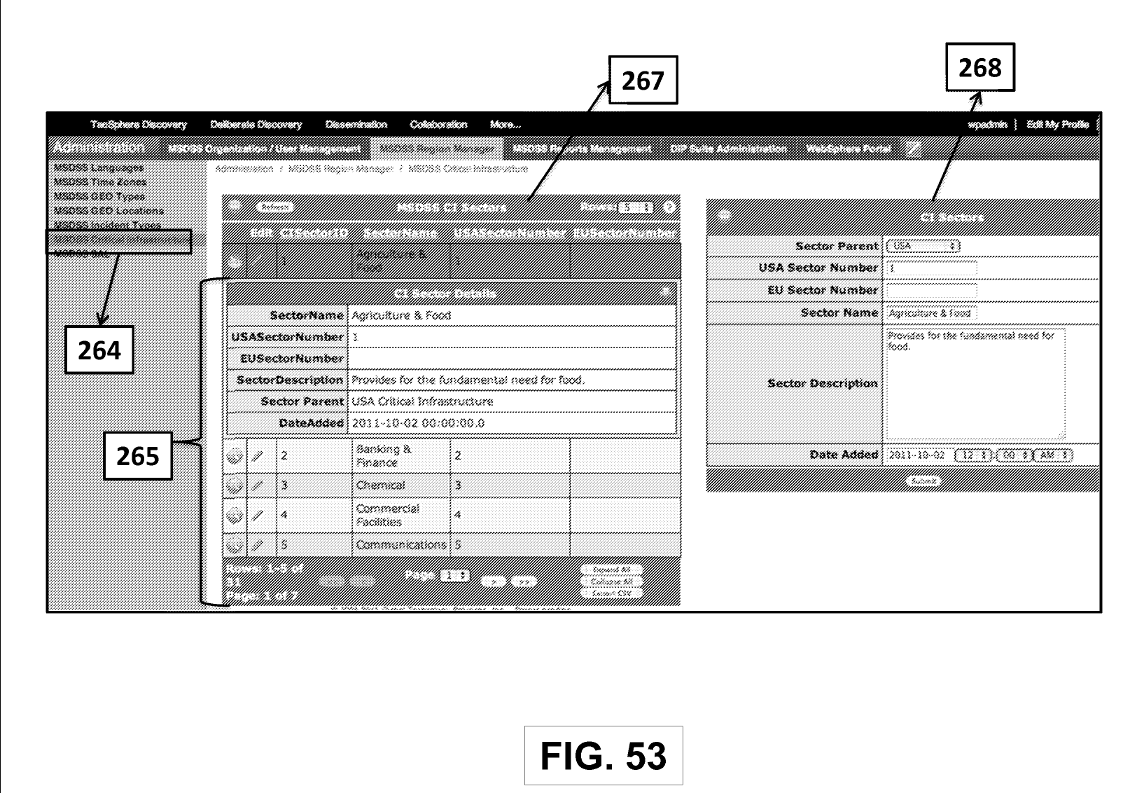

FIG. 53 illustrates the view in the Administration window that is displayed when a Regional Manager navigation tab 223 is selected, and when a Critical Infrastructure button 264 is selected. This view enables a user (e.g., an administrator) to define different countries critical infrastructure types that may be associated with infrastructure sectors in MSDSS on interactive maps and in reports. This view may include a form 267, titled CI Sectors, which includes a list 265 of defined critical infrastructure types, which may be associated with different infrastructure sectors. Each row in the list may identify critical infrastructure type by identification number, sector name, and different sector numbers for different countries. Rows in list 265 may be expandable to reveal additional details about the selected incident type. This view may also include a form 268 for creating and/or editing critical infrastructure types. Form 268 may include editable fields and selectable options for specifying the information in form 267 for a particular critical infrastructure type. The fields in form 268 may be auto-populated by selecting one of the critical infrastructure types listed in list 265. Form 268 may include a button (e.g., a Submit button), that when selected creates a new critical infrastructure type or updates the data of an existing critical infrastructure type.

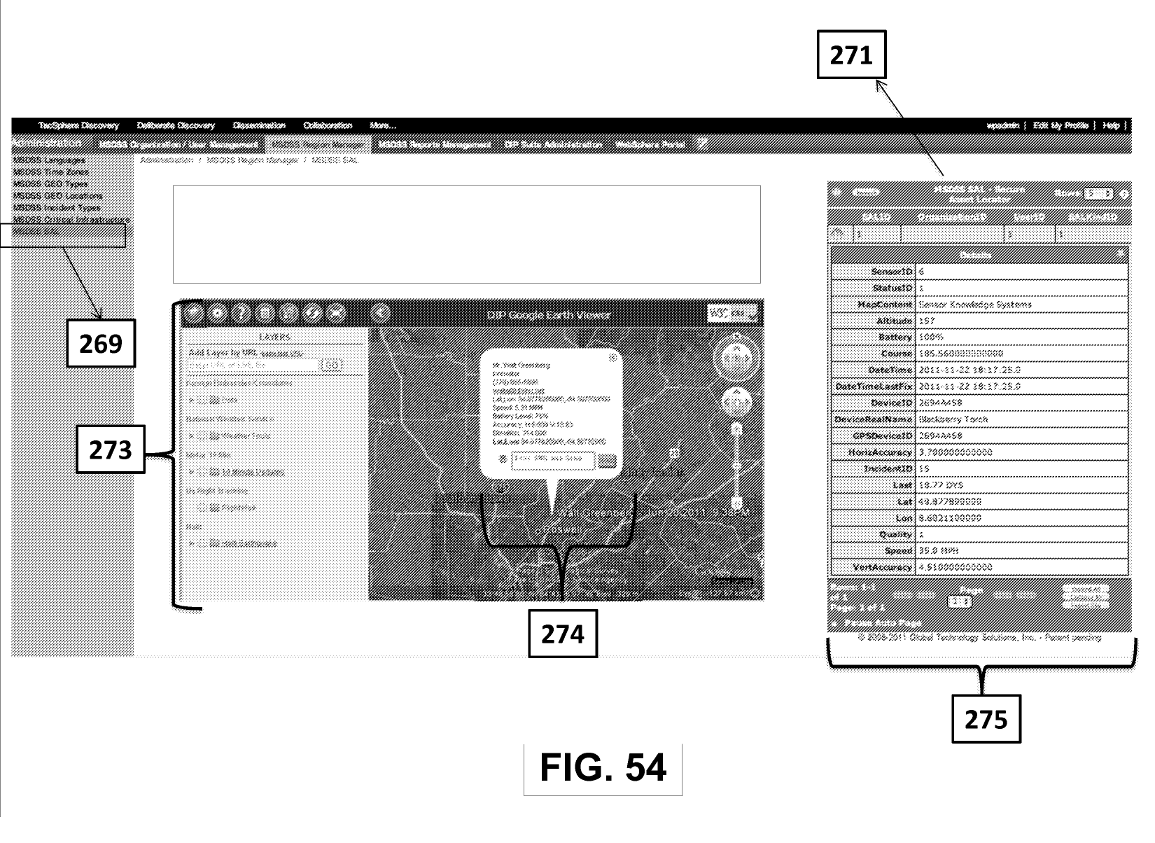

FIG. 54 illustrates the view in the Administration window that is displayed when a Regional Manager navigation tab 223 is selected, and when a Secure Asset Locator button 269 is selected. This view enables a user (e.g., an administrator) to manage an organization's asset locator. The view may receive location information from assets (e.g., as provided by GPS on the asset), and display the location information in a form 273 having an interactive map. Form 273 may plot historical organizational data of different topical data in one map for user to combine social data with layers of pertinent data. Within the interactive map, a user may select an asset, and in response to the selection a call out window 274 may be displayed with the asset information. The user can view the assets location and compare that location to other social data or events represented on the map. The view may include a form 271 that enables a user to manage the individual assets and connect and configure their devices providing the location information (e.g., GPS enabled devices). Each row in form 271 that lists an asset may be expanded to provide a detailed view of data associated with the asset. The information can be edited by the user, or a new asset may be created from the form.

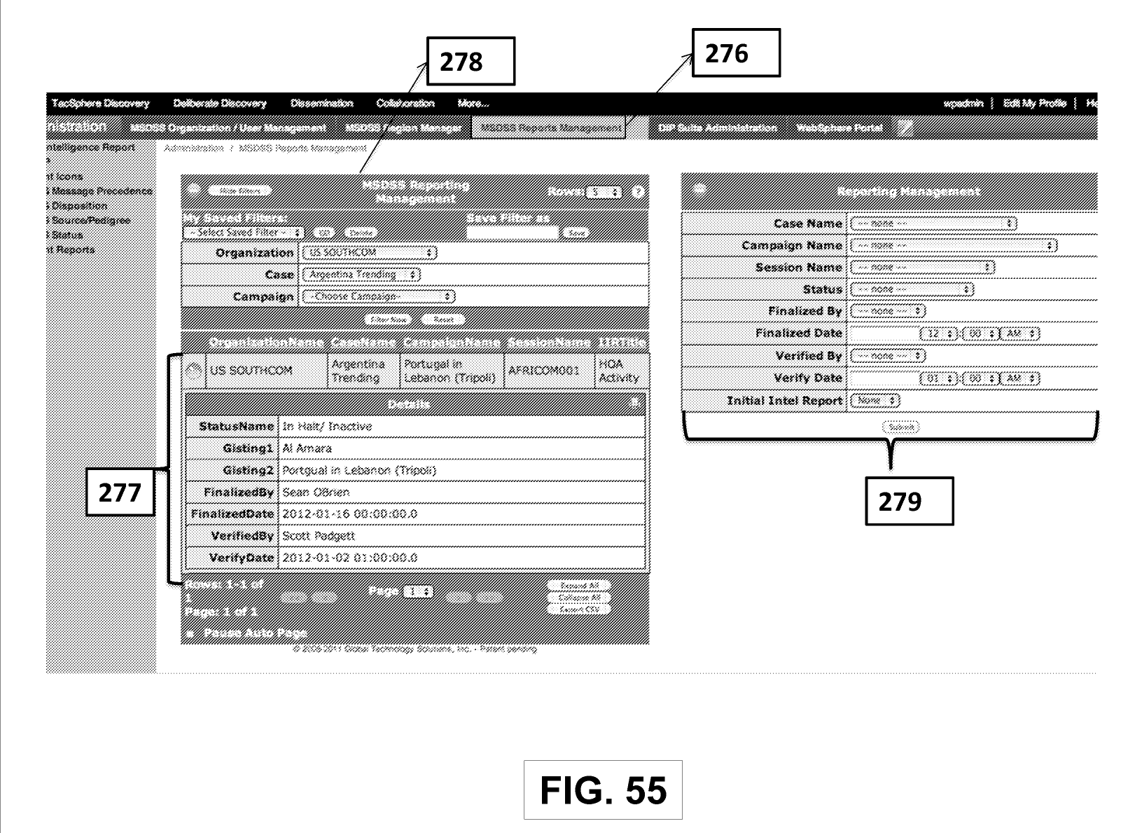

FIG. 55 illustrates the view in the Administration window (indicated by 221) that is displayed when a Reports Management navigation tab 276 is selected. This view enables a user (e.g., an administrator) to manage/define the life cycles of reports. This view may include a form 278 titled Reporting Management that includes a list 225 of reports for an organization. Each row of the list may identify a different report identified by organization name, case name, campaign name, session name, report title, etc. Form 278 may include one or more fields and scrollable menus (e.g., organization, case, campaign, etc.) for filtering the reports in the list. Each row may be arranged in a hierarchy based on an organization's matrix. Each row in the list may be expanded to view details about the report, including status of the report, gistings (running campaigns) covered by the report, authors and dates of generating the report parameters, etc. This view may also include a form 279 for creating and/or editing reports. Form 279 may include editable fields and selectable options for specifying the information in form 278 for a particular report. The fields and options in form 279 may be auto-populated by selecting one of the reports listed in list 277. Form 279 may include a button (e.g., a Submit button), that when selected creates a new report or updates the data of an existing report.

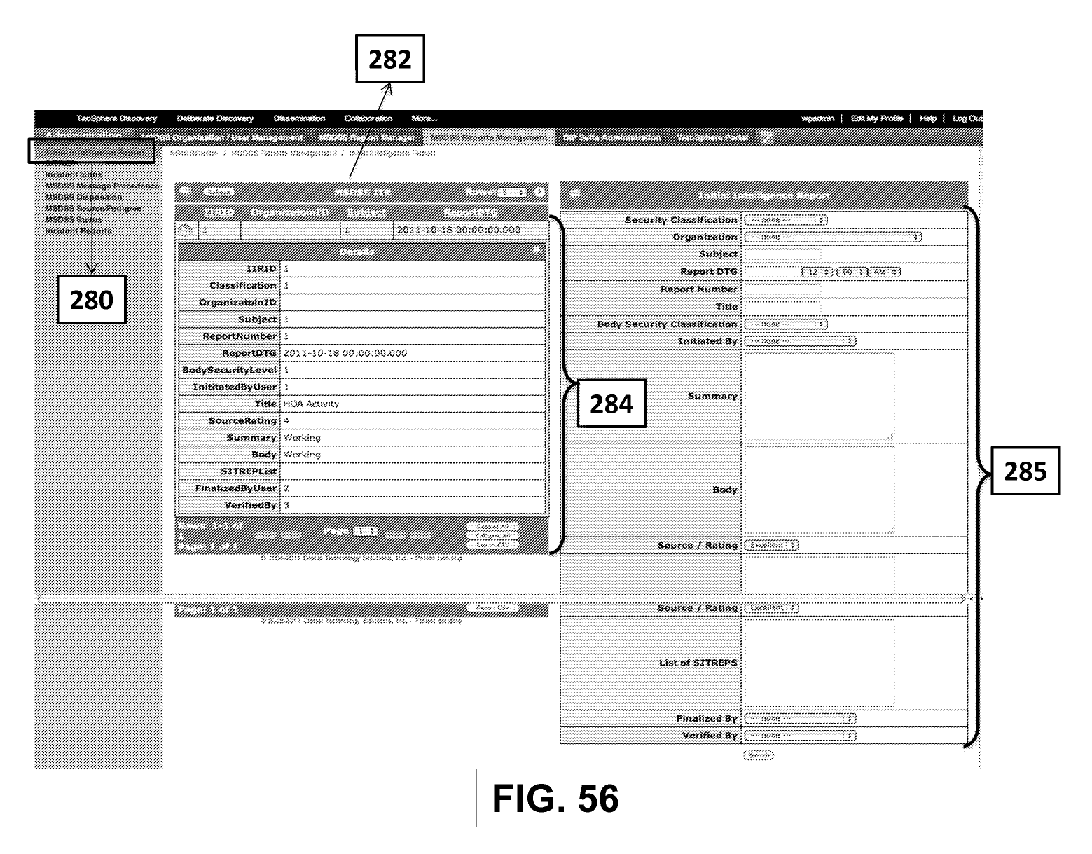

FIG. 56 illustrates the view in the Administration window (indicated by 221) that is displayed when a Reports Management navigation tab 276 is selected and when an Initial Intelligence Report (IIR) button 280 is selected. This view enables a user (e.g., an administrator) to create an IIR that may be associated, for example, a running session. This view may include a form 282 titled Initial Intelligence Report that includes a list 284 of IIRs for an organization. Each row of the list may identify a different IIR identified by, for example, identification number, organization ID, Subject, creation time, etc. Each row in the list 284 may be expanded to view details about the IIR, including security classification, organization ID, subject, report date, report number, title, author, summary, body of the report, source ratings, etc. This view may also include a form 285 for creating and/or editing IIRs. Form 285 may include editable fields and selectable options for specifying the information in form 284 for a particular IIR. The fields and options in form 285 may be auto-populated by selecting one of the reports listed in list 284. Form 285 may include a button (e.g., a Submit button), that when selected creates a new IIR or updates the data of an existing IIR, and may send the report to a collaborative environment for review of other users.

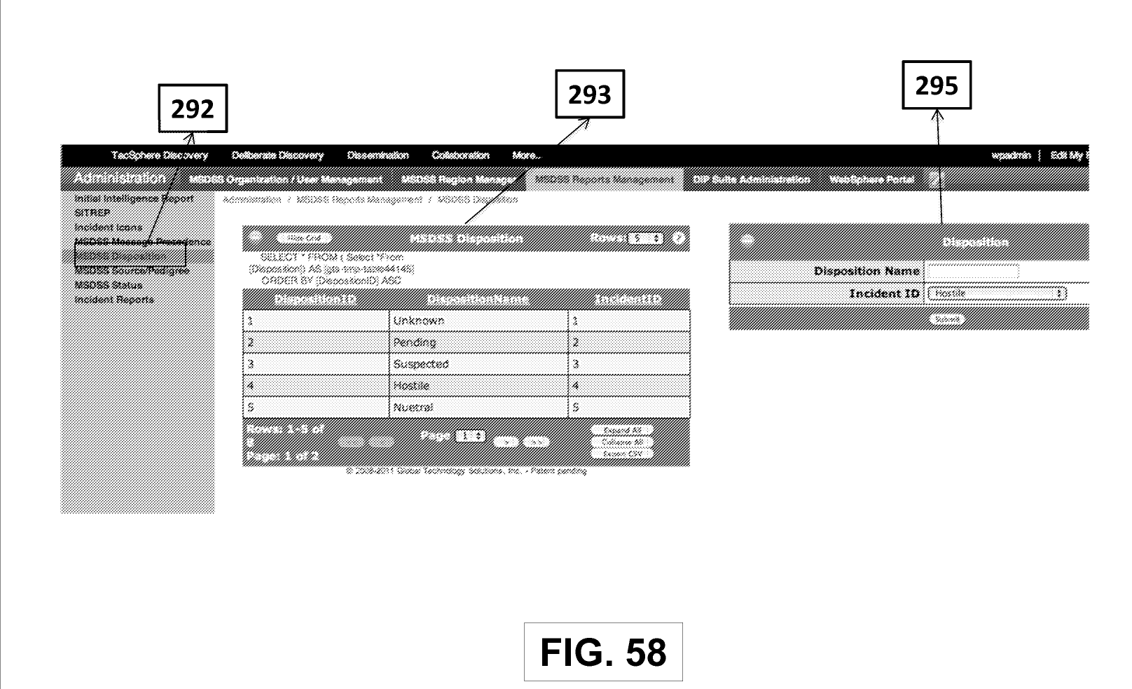

FIG. 58 illustrates the view in the Administration window that is displayed when a Reports Management navigation tab 276 is selected and when a Disposition button 292 is selected. This view may include a form 293 titled Disposition that includes a list of Dispositions that can be associated with an incident. Each row in the list may identify a different disposition and include an identification number, disposition name (e.g., unknown, pending, suspected, hostile, neutral, etc.). This view may also include a form 295 for creating and/or editing dispositions. Form 295 may include editable fields for specifying the information in form 293 for a particular disposition. The fields in form 295 may be auto-populated by selecting one of the dispositions in form 293. Form 295 may include a button (e.g., a Submit button), that when selected creates a new disposition or edits an existing disposition.

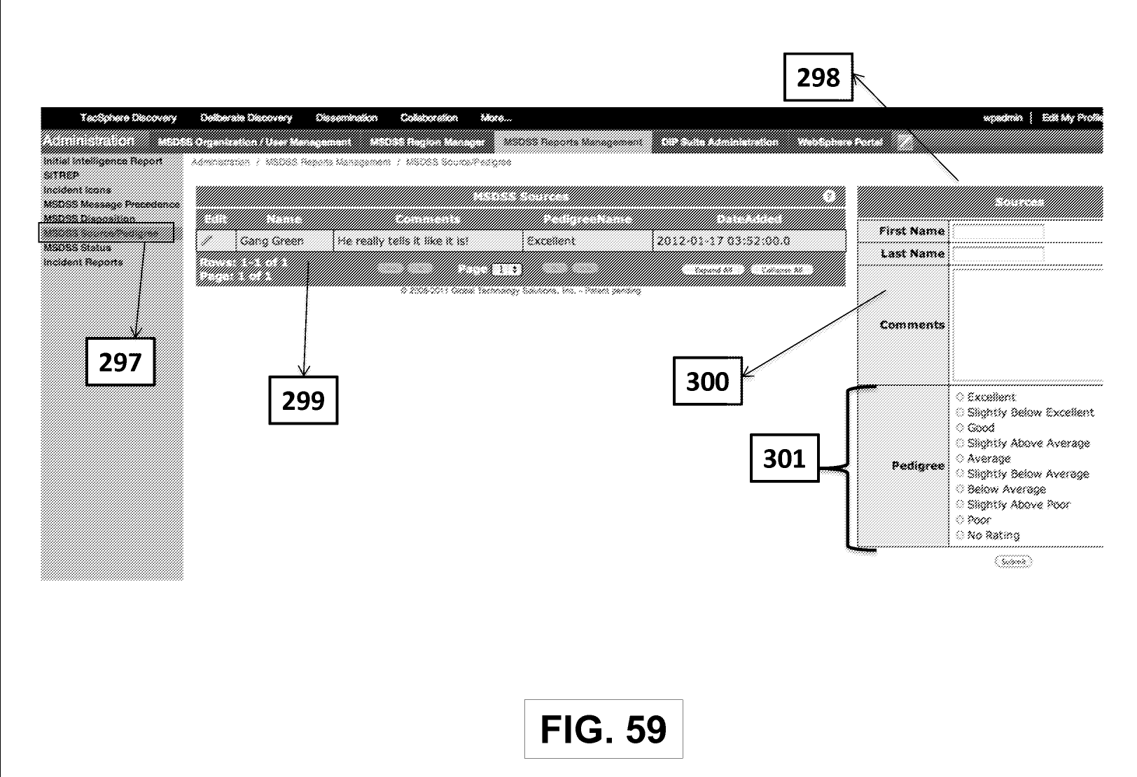

FIG. 59 illustrates the view in the Administration window that is displayed when a Reports Management navigation tab 276 is selected and when a Source/Pedigree button 297 is selected. This view may include a form 299 titled Sources that includes a list of sources from social networks and other data generators. Each row in the list may, for example, include a sources screen/login name, comments a user may enter regarding the source, a value/pedigree (e.g., excellent), a date the source was added, etc. Each row may be expanded to display further details associate with the source. This view may also include a form 298 for adding and/or editing sources. Form 298 may include editable fields for specifying the information in form 299 for a particular source. For example, field 300 may provide for adding comments and field 301 may provide for selecting predetermined pedigrees with the source. The fields in form 298 may be auto-populated by selecting one of the sources in form 299. Form 298 may include a button (e.g., a Submit button), that when selected creates a new source or edits an existing source.

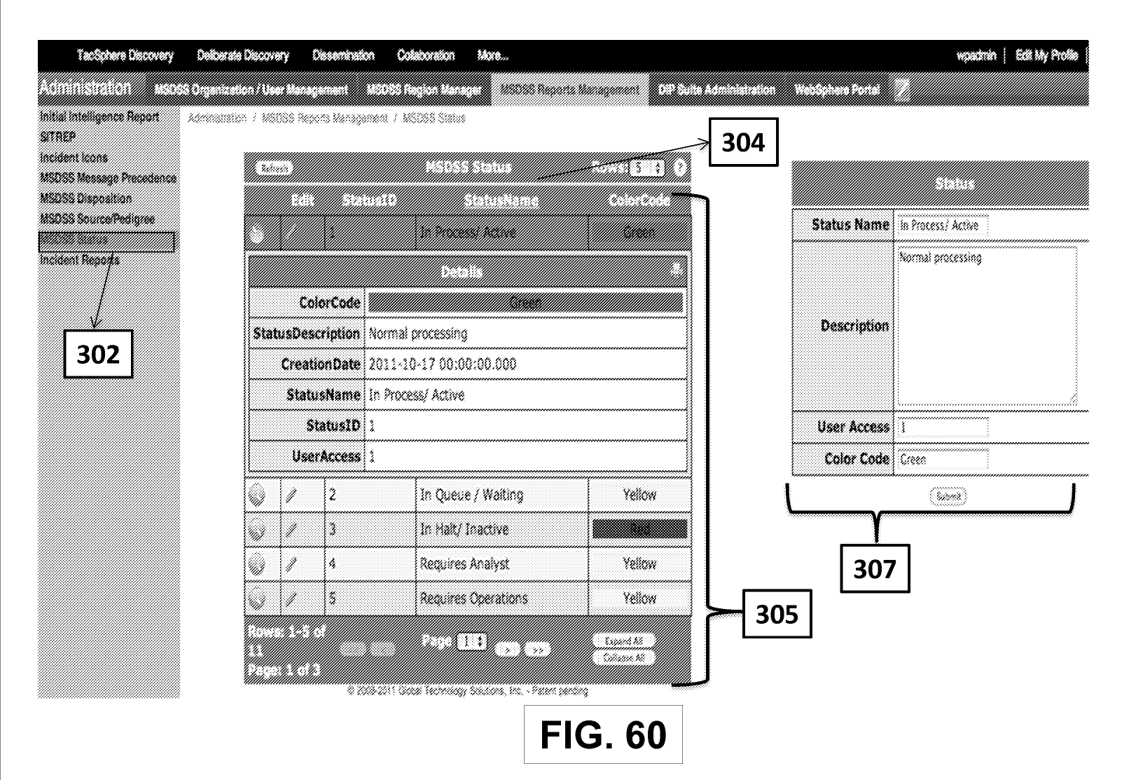

FIG. 60 illustrates the view in the Administration window that is displayed when a Reports Management navigation tab 276 is selected and when a Status button 302 is selected. This view enables a user to make adjustments to the color codes for status of reports. This view may include a form 304 titled Status that includes a list 305 of different status that can be associated with a report. Each row in the list may, for example, include a status identifier, status name, a color code, etc. Each row may be expanded to display further details associate with the status. This view may also include a form 307 for adding and/or editing status. Form 307 may include editable fields for specifying the information in form 304 for a particular status. The fields in form 307 may be auto-populated by selecting one of the sources in form 304. Form 307 may include a button (e.g., a Submit button), that when selected creates a new status or edits an existing status.

The foregoing description of embodiments has been presented for purposes of illustration and description. The foregoing description is not intended to be exhaustive or to limit embodiments to the precise form disclosed, and modifications and variations are possible in light of the above teachings or may be acquired from practice of various embodiments. The embodiments discussed herein were chosen and described in order to explain the principles and the nature of various embodiments and their practical application to enable one skilled in the art to utilize the present invention in various embodiments and with various modifications as are suited to the particular use contemplated. All embodiments need not necessarily achieve all objects or advantages identified above. Any and all permutations of various features described herein are within the scope of the invention. For example, all steps in the processes of FIG. 3 may not be performed, and the steps may be performed in a different order than how is illustrated and described. As another example, textual labels of features within the user interface presented in FIGS. 4-63 have been selected by way of example in the context of a Special Operating Forces (SOF) organization with an application in counter insurgency for illustrative purposes. Other labels specific to different organizations (e.g., a police force, an investment firm, an emergency relief organization, etc.) may alternatively be used.

1. An apparatus comprising:
one or more processors; and
one or more computer readable media storing computer executable instructions that when executed by the one or more processors causes the apparatus to:
receive one or more search strings;
receive parameters identifying a plurality of information sources connected to a network, the parameters including geospatial information associated with each of the information sources;
ingest data made available over the network the from the plurality of information sources;
compare the ingested data to the one or more search strings; and
output, to a display, a user interface including a map having identifiers plotted thereon, each identifier positioned on the map according to the geospatial information associated with a respect one of the information sources, and each identifier providing an indication of an outcome of the compare.
